(19) United States
(12) Patent Application Publication
(10) Pub. No.: US 2010/0273901 A1
(43) Pub. Date: Oct. 28, 2010

(54) MOLECULE SULFONATION PROCESS

(75) Inventors: Scott G. Ehrenberg, Port Richey, FL (US); Liwei Cao, Odessa, FL (US); David Vachon, Spokane, WA (US); Kevin Coppola, Baton Rouge, LA (US); James Balog, Altoona, PA (US)

Correspondence Address: MUETING, RAASCH & GEBHARDT, P.A., P.O. BOX 581336, MINNEAPOLIS, MN, 55458-1336, US

(73) Assignees: AEGIS BIOSCIENCES LLC, Odessa, FL (US); DAIS ANALYTIC CORPORATION, Odessa, FL (US)

(21) Appl. No.: 12/599,200

(22) PCT Filed: May 9, 2008
(86) PCT No.: PCT/US08/63243

§ 371 Date: Jul. 9, 2010

Related U.S. Application Data
(60) Provisional application No. 60/917,037, filed on May 9, 2007.

(51) Int. Cl. C08F 112/08; B01J 39/18

(52) U.S. Cl. 521/33; 525/333.5

(57) ABSTRACT

The present invention pertains to products and processes relating to sulfonating molecules, including nucleic acids, amino acids, peptides, polypeptides, oligomers, polymers, and copolymers. The disclosed process allows for a uniform and controlled level of sulfonating molecules. The sulfonated molecules produced by the disclosed process exhibit a high degree of uniform sulfonation as well as improved properties.

### CROSS REFERENCE TO RELATED APPLICATION

This application claims priority benefit of U.S. Provisional Application Ser. No. 60/917,037, filed May 9, 2007, which is incorporated herein in its entirety.

### FIELD OF THE INVENTION

The subject matter disclosed herein relates to a process for preparing sulfonated or polysulfonated molecules, including oligomers and/or polymers. The processes disclosed herein result in highly uniform sulfonated molecules, especially polymers. In one particular embodiment, the process is useful for preparing water insoluble oligomers or polymers, which are capable of forming phase, separated morphologies when they are solvent cast into films. In another particular embodiment, the uniformly sulfonated oligomer and/or polymer may be useful as an additive in electrochemical, biological or medical coatings, and consumer products, moisture transfer applications, including heat and/or fluid transfer membranes, moisture and/or heat transfer coatings, as well as other applications.

### BACKGROUND OF THE INVENTION

Sulfonation generally refers to an organic chemical reaction that leads to the formation of a carbon-sulfur bond. When the reacting compound contains an aromatic ring, sulfonation at the aromatic ring by the reactive (sulfonating) compound usually occurs by replacing a hydrogen atom on the aromatic ring by a sulfonic acid residue functional group by means of an electrophilic aromatic substitution reaction. However, with particular compounds, such as phenylalkanoic acids, sulfonation may occur on the carbon adjacent to the carboxyl group, rather than on the aromatic ring. In contrast to aromatic nitration or other electrophilic aromatic substitutions, aromatic sulfonation is reversible.

Sulfonation of aromatic compounds utilizing sulfur trioxide, sulfuric acid, chlorosulfonic acid, or acetyl sulfate as the sulfonating agent has been accomplished in the past with limited success. (Gilbert, Chem. Rev. 62: 549-589 (1962); German Patent No. DE 580,366). The process is expensive, difficult, and oftentimes results in incomplete sulfonation of the compound, especially for large molecular weight oligomers or polymers. (Gilbert, supra).

Moreover, the technique of using sulfur trioxide as the sulfonating agent results in the generation of considerable amounts of undesired side-products during the course of the sulfonation reaction and subsequent work-up due to the high reactivity of the sulfur trioxide. The sulfonation side-products are frequently difficult to remove and may contaminate the final sulfonated molecule product. (Gilbert, supra).

Thus, existing methods that describe using sulfur trioxide as a sulfonating reagent to sulfonate compounds resulted in non-uniform sulfonation, incomplete sulfonation, and a high rate of formation of undesirable side-products. Further, sulfonation reactions utilizing sulfur trioxide and other reagents have, in some cases, resulted in limited ability to create sulfonated products. This has especially been shown to be the case with attempts to sulfonate large molecular polymers. For example, excess sulfuric acid and acetic acid that result from the use of acetyl sulfate can only be removed by way of an elaborate, and expensive, absorption cleaning process or other means. Furthermore, the use of sulfuric acid introduces water into the reaction, which can alter the ability of the reaction components to effectively solvate. The introduction of water into the reaction through the use of sulfuric acid also prohibits sulfonating polymers with labile, or hydrolytically unstable, functional groups or moieties.

### SUMMARY OF THE INVENTION

The present invention is directed to methods for sulfonating molecules with sulfur trioxide. The methods allow for the sulfonation of molecules in a controllable manner, and with fewer undesirable side-products or degradation products. The methods of the invention produce relatively clean sulfonated molecules with a high degree of uniformity in the resulting sulfonation.

Accordingly, in one aspect, the invention provides a method or process for preparing a sulfonated molecule, the process comprising contacting a molecule with sulfur trioxide under suitable conditions to form a sulfonated molecule. The suitable conditions may be selected from the group consisting of: the presence of at least one inert solvent, the presence of at least one electron donor agent, a reaction temperature of between approximately −50° C. and 25° C., a reaction time of between 1 second and 30,000 seconds, mixing of between 500 rpm and 20,000 rpm, and a shear rate of between 5 s⁻¹ and 100 s⁻¹.

In certain embodiments, the process utilizes an inert solvent selected from the group consisting of: ethylene dichloride, perchloroethylene, trichloroethylene, 1,1,1-trichloroethane (1,1,1-TCA), dichloroethane (including 1,1-dichloroethane (1,1-DCA), and 1,2-dichloroethane (1,1-DCE)), carbon tetrachloride, vinyl chloride (VC), tetrachloroethane, chloroform (trichloromethane), dichloethane, methylene dichloride (MDC), tetrahydrofuran (THF), dimethylformamide (DMF), and dimethylacetamide (DMAC). In particularly preferred embodiments, the inert solvent comprises methylene dichloride or dichloroethane.

In certain embodiments, the reaction starting temperature comprises between approximately −25° C. and 20° C. Preferably, the reaction starting temperature comprises between approximately −20° C. and 0° C.

In certain embodiments, the reaction time comprises between approximately 2 seconds and 20,000 seconds. Preferably, the reaction time comprises between approximately 20 seconds and 1000 seconds.

In other embodiments, the process utilizes a molecule selected from the group consisting of: a nucleic acid, an amino acid, a peptide, a polypeptide, a protein, a glycoprotein, a biopolymer, an oligomer, a polymer, and a copolymer. In certain embodiments, the molecule comprises a statistical, random, or block copolymer, oligomer, or polymer or any combination thereof. In still other embodiments, the molecule comprises a multiphase large copolymer, oligomer, or polymer, or any combination thereof.

In certain embodiments, the molecule has a molecular weight of between approximately 100 grams/mole to approximately 500 grams/mole and contains at least one alkene or arene moiety. In other particular embodiments, the molecule further comprises at least one moiety selected from the group consisting of: arene-containing linear side chains, non-arene-containing linear side chains, saturated linear side chains, unsaturated linear side chains, and flexible hydrocarbon linear side chains. In still other embodiments, the molecule comprises at least one monomeric unit selected from the group consisting of: polyethylene (PE), polypropylene (PP), polyethylene oxide (PEO), polystyrene (PS), polyesters, polycarbonate (PC), polyvinyl chloride (PVC), nylon, halogenated polymers or copolymers such as perfluorinated copolymers, poly(methyl methacrylate) (PMMA), acrylonitrile butadiene styrene (ABS), polyamide (PA), polyurethane, polytetrafluoroethylene (PTFE), polylactic acid (PLA), polyvinylidene chloride (PVDC), styrene-butadiene rubber (SBR), styrene-ethylene/butylenes-styrene (SEBS); styrene-ethylene/propylene-styrene (SEPS), ethylene-styrene interpolymer (ESI), styrene acrylate, polyetherether ketone (PEEK), and polyethylene terephthalate (PET or PETE).

In certain embodiments, the electron pair donor agent is selected from the group consisting of: 1,2-dimethoxyethane, 1,4-dioxane, trimethylamine, triethylamine, pyridine, diethylaniline, 2-methlypyridine, 2,6-dimethylpyridine, N,N′-dimethyl ethylene diamine, and N-ethylmorpholine. In particular embodiments, the sulfur trioxide is present in the form of a coordination complex. In some such embodiments, the coordination complex comprises sulfur trioxide and the at least one inert solvent. In other such embodiments, the coordination complex comprises sulfur trioxide and the at least one electron pair donor agent.

In certain embodiments, the at least one inert solvent comprises methylene dichloride, the reaction starting temperature comprises between approximately −20° C. and −10° C., the reaction time comprises between approximately 1 second and 1000 seconds, the molecule comprises at least one monomeric unit susceptible to sulfonation, and the electron pair donor agent comprises 1,4-dioxane.

Certain other embodiments further comprise admixing the molecule in at least one inert solvent prior to contacting the molecule with the sulfur trioxide. Still other embodiments further comprise admixing the sulfur trioxide in at least one inert solvent prior to contact with the molecule. Other particular embodiments comprise admixing the molecule in at least one inert solvent and admixing the sulfur trioxide in at least one inert solvent prior to contacting the molecule with the sulfur trioxide.

Certain embodiments disclosed herein relate to a sulfonated molecule prepared by the process of any one of the processes disclosed herein. In certain embodiments, the sulfonated molecule prepared according to any one of the processes disclosed herein, wherein the molecule is sulfonated from approximately 2 to 100 mole percent. In certain other embodiments, the sulfonated molecule is uniformly sulfonated from approximately 20 to 80 mole percent.

Certain other embodiments disclosed herein relate to a disposable bodily fluid absorbing material comprising a sulfonated molecule prepared by any one of the processes disclosed herein. Certain embodiments relate to a surface coating comprising a sulfonated molecule prepared by any one of the processes disclosed herein. Certain other embodiments relate to an environmental control unit comprising a sulfonated molecule prepared by any one of the processes disclosed herein. Certain other embodiments relate to a moisture transfer membrane comprising a sulfonated molecule prepared by any one of the processes disclosed herein. Certain other embodiments relate to a heat transfer membrane comprising a sulfonated molecule prepared by any one of the processes disclosed herein. Certain other embodiments relate to a pharmaceutical composition comprising a sulfonated molecule prepared by any one of the processes disclosed herein. Certain other embodiments relate to a medical device comprising a sulfonated molecule prepared by any one of the processes disclosed herein. Certain other embodiments relate to a medical article comprising a sulfonated molecule prepared by any one of the processes disclosed herein. Still other embodiments relate to a building material comprising a sulfonated molecule prepared by any one of the processes disclosed herein. Still other embodiments relate to an ion conducting membrane comprising a sulfonated molecule prepared by any one of the processes disclosed herein. In certain embodiments, the ion conducting membrane comprising the sulfonated molecule is insoluble in water. Other embodiments relate to a fuel cell comprising the ion conducting membrane prepared with the sulfonated molecule disclosed. Still other embodiments relate to a fabric comprising the ion conducting membrane made by a sulfonated molecule disclosed. Other embodiments relate to a consumer product comprising the ion conducting membrane made by using a sulfonated molecule disclosed. Other particular embodiments relate to a wound dressing comprising the ion conducting membrane made by a sulfonated molecule disclosed.

Other particular embodiments relate to a composition comprising a sulfonated molecule, wherein the molecule contains at least one alkene or arene moiety and wherein the molecule is sulfonated from 20 to 99% by weight, based on the total weight of the molecule composition. In certain embodiments, the composition comprises a molecule that is sulfonated from 60 to 99% by weight, based on the total weight of the molecule composition. Still other embodiments relate to a composition comprising a sulfonated molecule, wherein the molecule contains at least one alkene or arene moiety, and wherein the molecule is sulfonated from 60 to 99% by weight, based on the total weight of the molecule composition.

Certain embodiments relate to an article comprising a sulfonated molecule, wherein the molecule contains at least one styrene monomeric unit, and wherein the molecule is sulfonated from 60 to 99% by weight, wherein the article is selected from the group consisting of: a membrane, a medical device, a pharmaceutical composition, a fluid-absorbing material, a fuel cell, a capacitor, a wound dressing, a fabric, a building material, a packing material, and a surface coating. Still other embodiments relate to a membrane comprising a sulfonated molecule, wherein the molecule contains at least one alkene or arene moiety, and wherein the molecule is sulfonated from 20 to 80% by weight. Still other embodiments relate to a membrane, wherein the molecule contains at least one arylene-vinyl monomeric unit. In certain embodiments, the molecule contains at least one styrene monomeric unit.

Certain other embodiments relate to a process for manufacturing a sulfonated molecule membrane comprising preparing a sulfonated molecule according to the processes disclosed, and further comprising adapting the sulfonated molecule for use as a membrane, thereby manufacturing the sulfonated molecule membrane. In certain embodiments, the membrane is a heat transfer membrane or a fluid transfer membrane.

Certain other embodiments relate to a process for manufacturing a medical device comprising a sulfonated molecule, the method of manufacturing comprising preparing a sulfonated molecule according to the processes disclosed, and further comprising adapting the sulfonated molecule for use as a medical device, thereby manufacturing the medical device comprising a sulfonated molecule.

### BRIEF DESCRIPTION OF THE SEVERAL VIEWS OF THE DRAWING(S)

FIG. 1 shows an exemplary apparatus used to test moisture transfer of membranes produced with sulfonated molecules generated by the disclosed process.

FIG. 2 represents a component of the moisture transfer testing apparatus of FIG. 1, specifically the controlled temperature water reservoir. In certain embodiments, the reservoir is composed of serpentine grooved chambers holding the polymeric membranes that are submerged in water, as indicated in other Figures.

FIG. 3 shows the airflow meter component of the moisture transfer testing apparatus used to test sulfonated polymeric membranes as described herein.

FIG. 4 shows the desiccant holding tube component of the moisture transfer testing apparatus used to test sulfonated polymeric membranes as described herein.

FIG. 5 depicts a schematic representation of one particular embodiment disclosed.

FIG. 6 shows the top view of the serpentine compartment of the water reservoir with nitrogen gas flow field.

FIG. 7 shows the bottom view of the serpentine compartment of the water reservoir.

FIG. 8 depicts a schematic representation of one particular set-up for testing exemplary membranes as disclosed herein.

FIG. 9 depicts a schematic representation of another particular set-up for testing exemplary membranes as disclosed herein.

### DETAILED DESCRIPTION OF THE INVENTION

The invention is directed to sulfonated molecules and methods or processes for preparing the same. It was surprisingly found that sulfonation with sulfur trioxide was possible using the disclosed methods and molecules, such as oligomers and/or polymers, which would otherwise degrade by hydrolysis, i.e. by acid, catalyzed cleavage of hydrolytically unstable bonds such as with acetyl-sulfate. The disclosed processes may be utilized for sulfonating small molecules or large molecules, such as multiphase copolymers, containing alkene or arene moieties.

In certain embodiments disclosed herein, the method or process entails sulfonating a polymer, such as a solid polymerized styrene, in a solvent that does not chemically react in the sulfonation process, and optionally using a coordination complex of sulfur trioxide and wherein at least one electron pair donor molecule is optionally present in the reaction solution. In certain embodiments, at least one or more polymers, and a coordination complex of sulfur trioxide and at least one electron pair donor molecule are dissolved in one or more non-reactive solvent(s). In certain other embodiments, all of the reaction components are dissolved in one or more non-reactive solvent(s). In certain embodiments the one or more non-reactive solvent(s) may form a coordination complex with the sulfur trioxide. In the particular embodiments wherein the non-reactive solvent forms a coordination complex with the sulfur trioxide, additional electron pair donor molecules may optionally be present in the reaction solution.

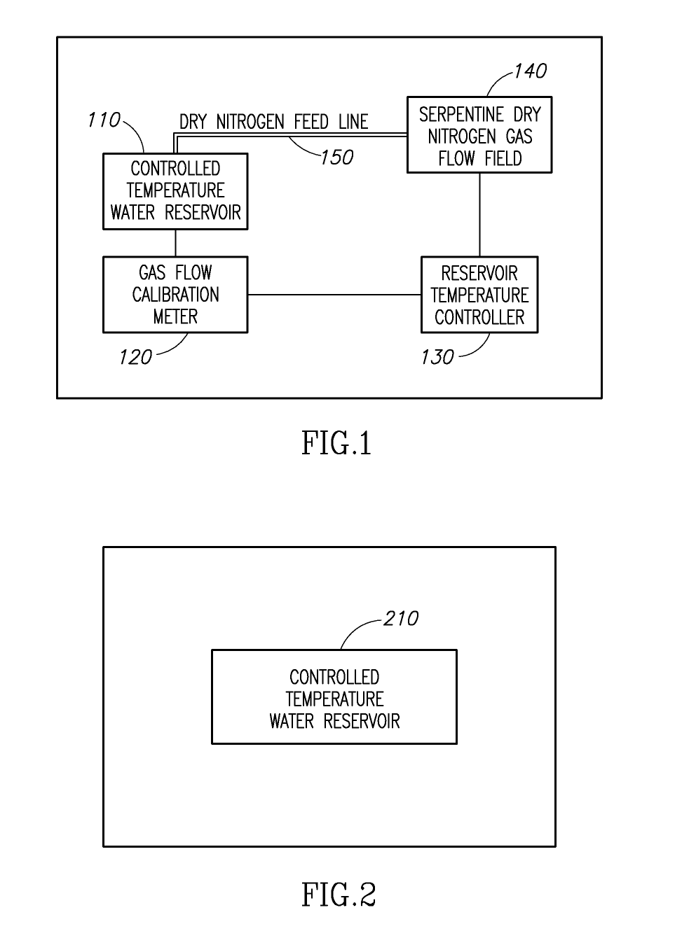

In certain embodiments disclosed herein, the membranes made by the molecule sulfonation process described herein may be tested for various properties according to a particular set-up. For example, FIG. 1 indicates a set-up for testing fluid transfer properties of the membrane. As indicated, the set-up is composed of a controlled temperature water reservoir 110, connected to a gas flow calibration meter 120, and also connected by way of a dry nitrogen feed line 150 to a serpentine dry nitrogen gas flow field 140. The nitrogen gas flow field and the gas flow calibration meter are connected to the reservoir temperature controller 130.

FIG. 2 is a block diagram indicating the controlled temperature water reservoir 210 as an isolated component of the apparatus testing system.

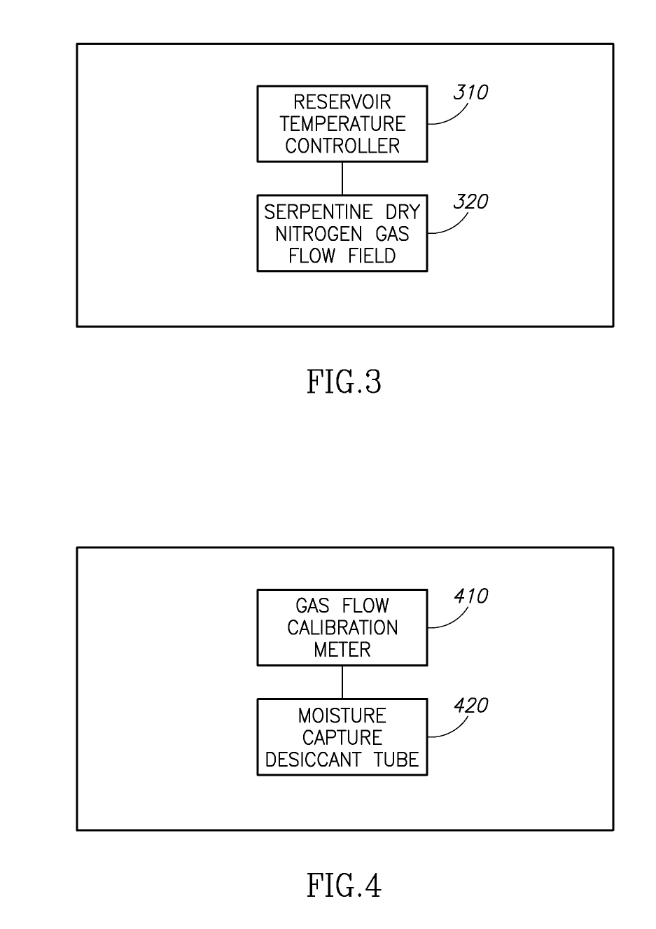

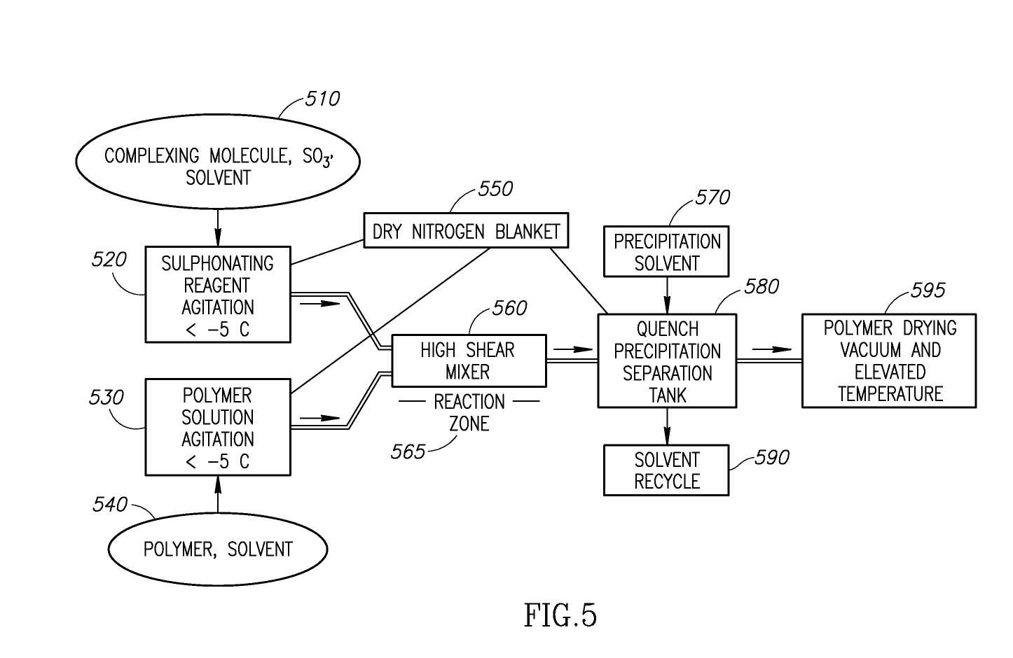

FIG. 3 illustrates the reservoir temperature controller 310 joined to the serpentine dry nitrogen gas flow field 320. FIG. 4 illustrates the gas flow calibration meter 410 joined to the moisture capture desiccant tube 420. FIG. 5 depicts a schematic of one exemplary embodiment of the molecule sulfonation process described herein. As indicated, the complexing molecule, SO₃, and solvent are combined in step 510 and agitated at low temperatures according to step 520. In a separate step 540, the polymer and solvent are combined and also agitated at low temperature as set forth in step 530. Next, the sulphonating reagent agitation mixture 520 and the polymer agitation solution 530 are combined in a high shear mixer 560 in a reaction zone 565. The mixture is passed along to a quench precipitation separation tank 580, where solvent is recycled at step 590, by precipitation solvent 570. Finally, the polymer is dried on a vacuum at elevated temperature in step 595. For steps 520, 530, and 580, a dry nitrogen blanket 550 is preferred.

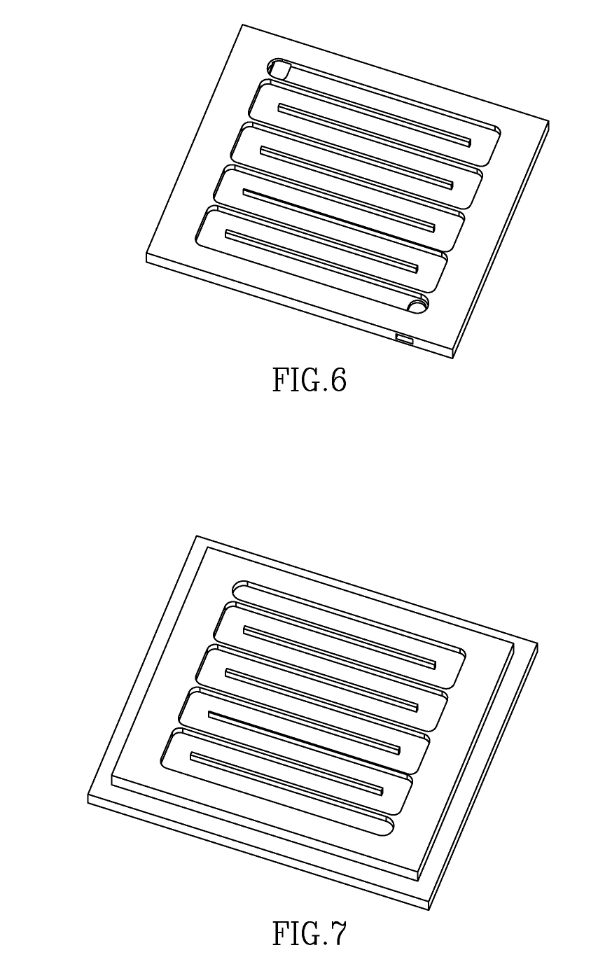

FIG. 6 indicates a detailed top view of the serpentine water reservoir with nitrogen gas flow and controlled temperature. FIG. 7 shows a detailed bottom view of the serpentine water reservoir with nitrogen gas flow and controlled temperature reservoir.

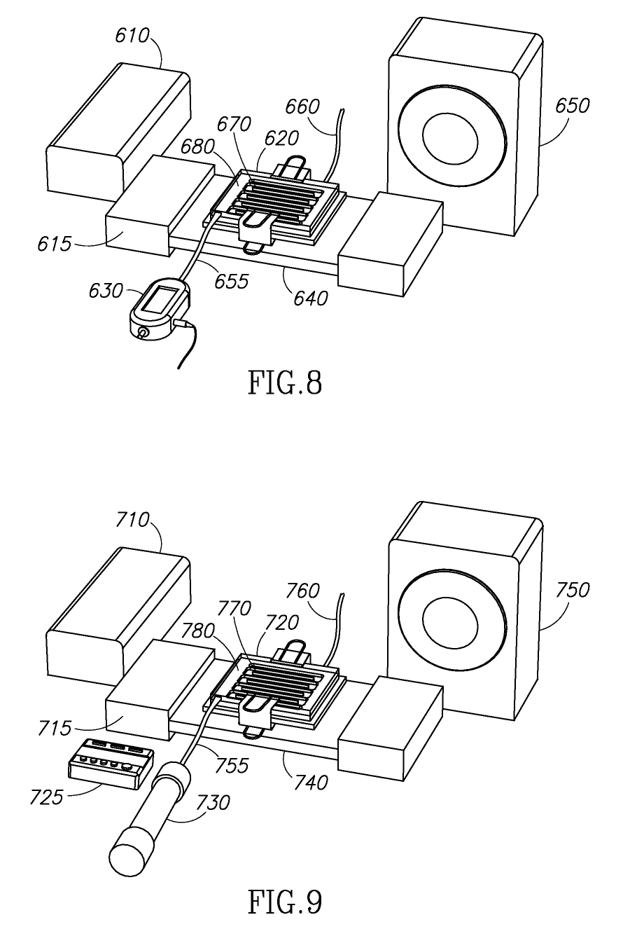

FIG. 8 depicts a schematic of one embodiment of the apparatus set-up for testing a sample membrane 620. The sandwich testing device 680 is composed of the serpentine water reservoir 670, the sample membrane 620, and the nitrogen flow field and the support structure 640 beneath the device. The serpentine water reservoir 670 houses the sample membrane 620. A nitrogen flow calibration instrument 630 measures the nitrogen that is fed across the membrane 620 by the nitrogen feed tube 660. The nitrogen flow calibration instrument 630 is connected to the sandwich device 680 by a connecting line 655. The temperature is controlled by the temperature control unit 610 which is connected to the sandwich testing device 680 by a subunit 615. The temperature and humidity are monitored by a sensor 650.

FIG. 9 depicts a schematic of another embodiment of the apparatus set-up for testing a sample membrane 720. The sandwich testing device 780 is composed of the serpentine water reservoir 770, the sample membrane 720, and the nitrogen flow field. The device is supported by the support structure 740 beneath the device. A nitrogen feed tube 760 provides nitrogen across the membrane 720. The temperature is controlled by the temperature control unit 710 which is connected to the sandwich testing device 780 by a subunit 715. The temperature and humidity are monitored by a sensor 750.

The flow field of the serpentine water reservoir 770 guides the dry nitrogen gas over the surface of the sample membrane 720. The membrane 720 is sealed between the flow field serpentine vessel and the temperature controlled water reservoir 770. The temperature of the reservoir sets the humidity level (moisture gas density) beneath the membrane 720. As the nitrogen gas travels through the flow field, it picks up moisture that permeates through the membrane 720. A dessicant tube 730 captures the moisture and increases in mass (weight). The increase in mass is measured over a pre-determined period (such as a 10 minute period) and a moisture flux rate is calculated for the membrane 720 at that moisture gas density and nitrogen flow rate. Thus, the change in mass of the dessicant tube 730 is equivalent to the water transferred. The gas flow meter checks the nitrogen flow rate before the inception of the 10 minute test as part of the calibration. The temperature and humidity are monitored by the sensor 750. A timer 725 records the run.

### Molecules

As disclosed herein, specific embodiments of the sulfonation method or process of the invention comprise sulfonating molecules with sulfur trioxide. The molecules (including macromolecules) utilized in the methods or processes of the invention include, but are not limited to, nucleic acids (nucleotides), amino acids, peptides, polypeptides, proteins, glycoproteins, biopolymers, oligomers and/or polymers and/or copolymers containing either alkene and/or arene and/or hydroxyl moieties. A macromolecule, as used herein, generally refers to a molecule of high relative molecular mass, the structure of which typically comprises multiple repetition of segments derived from other molecules, such as for certain oligomers, polymers, or co-polymers. A biopolymer, as used herein, generally refers to a polymer that—at least in part--can be produced by or found in living organisms, and includes sugars (monosaccharides, disaccharides, polysaccharides, starches, and the like); amino acids; nucleotides (including oligomers); peptides; polypeptides; proteins; DNA; RNA; proteoglycans; glycoproteins, and any combination thereof. In addition, a biopolymer may comprise a combination of a naturally occurring polymer and a synthetic polymer. Some examples of combinations of biopolymers and synthetic polymers include peptidomimetics, non-natural amino acids or peptides, polypeptides and proteins containing non-natural amino acids, and others. See, for example, WO2003/020735, and Strott, Endocrine Reviews; 23(5):703-732; 2002.

The molecules utilized in the methods or processes of the invention may be naturally occurring, artificial, or any combination thereof. The molecules disclosed may be isolated or in a mixture or solution and/or may be chemically synthesized. The molecules may be modified (such as by reducing or dehydrogenating) prior to or subsequent to sulfonating.

As described inter alia, the molecules utilized in the processes disclosed herein may include, but are not limited to, bio-polymers, oligomers and/or polymers, such as multiphase large molecular chain polymers and/or copolymers. Particular embodiments include, but are not limited to, (a) oligomers and/or polymers and/or copolymers comprising an ion-containing polymer, (b) biopolymers, or (c) block copolymers.

In certain embodiments, molecules utilized in the methods or processes of the invention comprise an ion-containing oligomeric segment or co-oligomeric segment (ionomer). Typically, ionomers utilized in the present invention relate to polyelectrolyte polymers or copolymers that contain both nonionic repeat units and at least a small amount of ion containing repeating units.

Polymers of various degrees of polymerization are also included in the present invention. As one of skill in the art would readily appreciate, the degree of polymerization generally refers to the number of repeat units or segments in an average polymer chain at a particular time in a polymerization reaction, where length is measured by monomer segments or units. Preferable lengths include, but are not limited to, approximately 500 monomer units, 1000 monomer units, 5000 monomer units, 10,000 monomer units, 25,000 monomer units, 50,000 monomer units, 100,000 monomer units, 200,000 monomer units, 300,000 monomer units, 500,000 monomer units, 700,000 monomer units, or greater or any value there between.

The degree of polymerization may also be a measure of the polymer's molecular weight. Thus, the degree of polymerization is equal to the total molecular weight of the polymer divided by the total molecular weight of the repeating unit or segment. Polymers with different total molecular weights but identical composition may exhibit different physical properties. Generally, the greater the degree of polymerization correlates with the greater melting temperature and greater mechanical strength.

In certain embodiments, the oligomer and/or polymer and/or co-polymer comprises a multiphase large molecular chain molecule. In some embodiments the multiphase large molecular chain oligomers and/or polymers and/or copolymers comprise one or more arene-containing linear side chains, non-arene-containing linear side chains, saturated linear side chains, unsaturated linear side chains, or flexible hydrocarbon linear side chains.

For purposes of this invention, an “alkene moiety” refers to a hydrocarbon chain containing at least one carbon-carbon double bond. An “arene moiety” refers to a monovalent or divalent aryl or heteroaryl group. An aryl group refers to hydrocarbon ring system comprising hydrogen, 6 to 18 carbon atoms and at least one aromatic ring. For purposes of this invention, the aryl group may be a monocyclic, bicyclic, tricyclic or tetracyclic ring system, which may included fused or bridged ring systems. Aryl groups include, but are not limited to, aryl groups derived from aceanthrylene, acenaphthylene, acephenanthrylene, anthracene, azulene, benzene, chrysene, fluoranthene, fluorene, as-indacene, s-indacene, indane, indene, naphthalene, phenalene, phenanthrene, pyrene, and triphenylene. Preferably, an aryl group is derived from benzene. A heteroaryl group refers to a 5- to 14-membered ring system comprising hydrogen atoms, one to thirteen carbon atoms, one to six heteroatoms selected from the group consisting of nitrogen, oxygen and sulfur, and at least one aromatic ring. For purposes of this invention, the heteroaryl group may be a monocyclic, bicyclic, tricyclic or tetracyclic ring system, which may include fused or bridged ring systems; and the nitrogen, carbon or sulfur atoms in the heteroaryl radical may be optionally oxidized; the nitrogen atom may be optionally quaternized. Examples include, but are not limited to, azepinyl, acridinyl, benzimidazolyl, benzindolyl, 1,3-benzodioxolyl, benzofuranyl, benzooxazolyl, benzothiazolyl, benzothiadiazolyl, benzo[b][1,4]dioxepinyl, benzo[b][1,4]oxazinyl, 1,4-benzodioxanyl, benzonaphthofuranyl, benzoxazolyl, benzodioxolyl, benzodioxinyl, benzopyranyl, benzopyranonyl, benzofuranyl, benzofuranonyl, benzothienyl (benzothiophenyl), benzothieno[3,2-d]pyrimidinyl, benzotriazolyl, benzo[4,6]imidazo[1,2-a]pyridinyl, carbazolyl, cinnolinyl, cyclopenta[d]pyrimidinyl, 6,7-dihydro-5H-cyclopenta[4,5]thieno[2,3-d]pyrimidinyl, 5,6-dihydrobenzo[h]quinazolinyl, 5,6-dihydrobenzo[h]cinnolinyl, 6,7-dihydro-5H-benzo[6,7]cyclohepta[1,2-c]pyridazinyl, dibenzofuranyl, dibenzothiophenyl, furanyl, furanonyl, furo[3,2-c]pyridinyl, 5,6,7,8,9,10-hexahydrocycloocta[d]pyrimidinyl, 5,6,7,8,9,10-hexahydrocycloocta[d]pyridazinyl, 5,6,7,8,9,10-hexahydrocycloocta[d]pyridinyl,isothiazolyl, imidazolyl, indazolyl, indolyl, indazolyl, isoindolyl, indolinyl, isoindolinyl, isoquinolyl, indolizinyl, isoxazolyl, 5,8-methano-5,6,7,8-tetrahydroquinazolinyl, naphthyl, naphthyridinyl, 1,6-naphthyridinonyl, oxadiazolyl, 2-oxoazepinyl, oxazolyl, oxiranyl, 5,6,6a,7,8,9,10,10a-octahydrobenzo[h]quinazolinyl, 1-phenyl-1H-pyrrolyl, phenazinyl, phenothiazinyl, phenoxazinyl, phthalazinyl, pteridinyl, purinyl, pyrrolyl, pyrazolyl, pyrazolo[3,4-d]pyrimidinyl, pyridinyl, pyrido[3,2-d]pyrimidinyl, pyrido[3,4-d]pyrimidinyl, pyrazinyl, pyrimidinyl, pyridazinyl, pyrrolyl, quinazolinyl, quinoxalinyl, quinolinyl, quinuclidinyl, isoquinolinyl, tetrahydroquinolinyl, 5,6,7,8-tetrahydroquinazolinyl, 5,6,7,8-tetrahydrobenzo[4,5]thieno[2,3-d]pyrimidinyl, 6,7,8,9-tetrahydro-5H-cyclohepta[4,5]thieno[2,3-d]pyrimidinyl, 5,6,7,8-tetrahydropyrido[4,5-c]pyridazinyl, thiazolyl, thiadiazolyl, triazolyl, tetrazolyl, triazinyl, thieno[2,3-d]pyrimidinyl, thieno[3,2-d]pyrimidinyl, thieno[2,3-c]pridinyl, and thiophenyl (i.e. thienyl).

For purposes of this invention, an “arene-containing linear side chain” refers to an unbranched hydrocarbon chain consisting only of hydrogen or carbon, wherein at least one carbon in the chain is replaced with an aryl or heteroaryl group, as defined above.

For purposes of this invention, a “non-arene-containing linear side chain” refers to an unbranched hydrocarbon chain consisting only of hydrogen or carbon and containing no aryl or heteroaryl groups within the chain.

For purposes of this invention, a “saturated linear side chain” refers to an unbranched hydrocarbon chain consisting only of hydrogen or carbon comprising at least one carbon-carbon double bond or at least one carbon-carbon triple bond. An “unsaturated linear side chain,” as used herein, generally refers to an unbranched hydrocarbon chain consisting only of hydrogen or carbon containing no carbon-carbon double bonds and no carbon-carbon triple bonds.

For purposes of this invention, a “flexible hydrocarbon linear side chain” refers to a flexible connecting component as taught by U.S. Pat. Nos. 5,468,574 and 5,679,482, of which the disclosures of both are hereby incorporated by reference in their entireties.

For purposes of this invention, a “hydroxyl moiety” may refer to an oxygen atom and a hydrogen atom connected by a covalent bond.

The sulfonation process disclosed herein is particularly beneficial to sulfonating multiphase large molecules. The weight of the molecules utilized in the disclosed methods or processes are preferably at least approximately 10,000 Daltons, 15,000 Daltons, 20,000 Daltons, 25,000 Daltons, 30,000 Daltons, 40,000 Daltons, 50,000 Daltons, 60,000 Daltons, 70,000 Daltons, 80,000 Daltons, 90,000 Daltons, 1 KiloDalton, 2 KiloDaltons, 3 KiloDaltons, 4 KiloDaltons, 5 KiloDaltons, or greater or any value there between. Preferably, the size of the molecules is at least approximately 20,000 Daltons, 50,000 Daltons, 75,000 Daltons, 1 KiloDalton, 2 KiloDaltons, or any value there between.

In other embodiments, the measurement of molecular weight may be important. The average range of molecular weight (Mw) of the molecules disclosed herein includes from about 20,000 grams/mole to about 1,000,000 grams/mole, and preferably from about 50,000 grams/mole to 900,000 grams/mole.

In general, ionomers utilized in the methods or processes of the invention contain both polar and non-polar moieties. The nonpolar moieties of an ionomer are grouped together, while the polar ionic moieties tend to cluster together and separate from the nonpolar polymer backbone moieties. This ionic moiety clustering allows for thermoplasticity of the ionomers. Generally, when ionomers are heated, the ionic moieties will lose their attraction for each other and the moieties will freely move, thus allowing for thermoplastic elastomeric qualities of the ionic polymer or copolymer.

The processes disclosed herein result in little to no crosslinking, or anhydride formation, with the sulfonated ionomeric polymers, even when the polymers contain unsaturated moieties. Without wishing to be bound by any particular theory, the sulfonation process disclosed herein may react with the unsaturated moiety, resulting in sulfonation at one or more terminal portion of the polymer.

Various types of copolymers, including block copolymers, exist that may be used with the methods or processes of the invention. For example, alternating copolymers comprise regular alternating A and B chemical or constitutional units; periodic copolymers contain A and B units arranged in a repeating sequence (e.g. (A-B-A-B-B-A-A-A-B-B)ₙ); random copolymers comprise random sequences of monomer A and B units; statistical copolymers comprise an ordering of distinct monomers within the polymer sequence that obeys statistical rules; block copolymers that are comprised of two or more homopolymer subunits linked by covalent bonds and may be diblock, tri-block, tetra-block or multi-block copolymers. (IUPAC, Pure Appl. Chem., 68: 2287-2311 (1996)).

Additionally, any of the copolymers described may be linear (comprising a single main chain), or branched (comprising a single main chain with one or more polymeric side chains). Branched copolymers that have side chains that are structurally distinct from the main chain are known as graft copolymers. Individual chains of a graft copolymer may be homopolymers or copolymers, and different copolymer sequencing is sufficient to define a structural difference. For example, an A-B diblock copolymer with A-B alternating copolymer side chains is considered a graft copolymer. Other types of branched copolymers include star, brush and comb copolymers. Any one of these copolymers, or any mixture thereof, may be utilized with certain aspects of the disclosed process.

In certain embodiments disclosed herein, the molecule utilized in the methods or processes of the invention comprises a polymer comprised of at least one block. In certain embodiments, the molecule is a thermoplastic block copolymer. In other embodiments, the molecule is a block copolymer that comprises differentiable monomeric units. Preferably, at least one of the monomeric units of the block copolymer comprises an arene moiety-containing unit. In other preferred embodiments, at least one block comprises a non-arene moiety-containing unit. In certain embodiments, the block copolymer comprises at least two monomeric units arranged in statistically random order. In other embodiments, the block copolymer comprises at least two monomeric units arranged in ordered sequence. In certain embodiments, the molecule utilized in the processes disclosed herein includes not only polymers or block copolymers, but also copolymers with other ethylenically unsaturated monomers (such as acrylonitrile, butadiene, methyl methacrylate, etc.).

In certain embodiments disclosed herein, a block copolymer refers to a block copolymer having at least a first block of one or more mono alkene-arene moiety, such as styrene, ring-substituted styrene, α-substituted styrene, and any combination thereof; and a second block of a controlled distribution copolymer of a diene moiety and a mono alkene-arene moiety. The block copolymer can be any configuration of “A” and “B” blocks, and such block copolymers can be generated by methods known in the art.

For purposes of this invention, a “mono alkene-arene moiety” refers to one or more alkene moieties, as defined above, covalently bonded to an arene moiety, as defined above. An example of a “mono alkene-arene moiety” is styrene. A “poly alkene-arene moiety” refers to a two or more mono alkene-arene moieties, as defined above, covalently bonded to each other to form a chain comprising two or more mono alkene-arene moieties. An example of a “poly alkene-arene moiety” is polystyrene. A “diene moiety” refers to a hydrocarbon chain containing two carbon-carbon double bonds. In certain embodiments, the diene moiety may be conjugated, unconjugated, or cumulated.

Some specific examples of block copolymers include those described in U.S. Pat. Nos. 4,248,821; 5,239,010; 6,699,941; 7,186,779; 7,169,850; 7,169,848; 7,067,589; 7,001,950 and 6,699,941 and U.S. Patent Application Publication Nos. 20070021569; 20050154144; 20070004830; 20070020473; 20070026251; 20070037927; and 20070055015, all of which are incorporated herein by reference in their entireties.

In certain embodiments, the molecule comprises a statistical copolymer. A statistical copolymer is used herein consistent with the commonly understood usage in the art (see, for example, G. Odian, Principles of Polymerization, 1991). Statistical copolymers are derived from the simultaneous polymerization of two monomers and have a distribution of the two monomeric units along the copolymer chain, which follows Bernoullian (zero-order Markov), or first or second order Markov statistics. The polymerization may be initiated by free radical, anionic, cationic or coordinatively unsaturated (e.g., Ziegler-Natta catalysts) species. According to Ring et al., (Pure Appl. Chem., 57, 1427, 1985), statistical copolymers are the result of elementary processes leading to the formation of a statistical sequence of monomeric units that do not necessarily proceed with equal probability.

These processes can lead to various types of sequence distributions comprising those in which the arrangement of monomeric units tends toward alternation, tends toward clustering of like units, or exhibits no ordering tendency at all. Bernoullian statistics is essentially the statistics of coin tossing; copolymers formed via Bernoullian processes have the two monomers distributed randomly and are referred to as random polymers. For example, it is possible in a free radical copolymerization for the active end, in the case of one embodiment, a styryl or butadienyl radical, to have essentially no selectivity for styrene vs. butadiene. If so, the statistics will be Bernoullian, and the copolymer obtained will be random. More often than not, there will be a tendency for the propagating chain end to have some selectivity for one monomer or the other. In some cases block copolymers can be derived from the simultaneous copolymerization of two monomers when the preference of the propagating chain ends for adding the opposite monomers is very low. The resulting polymer would be categorized as a block copolymer for the purposes of the present invention.

Statistical copolymers generally display a single glass transition temperature. Block and graft copolymers typically display multiple glass transitions, due to the presence of multiple phases. Statistical copolymers are, therefore, distinguishable from block and graft copolymers on this basis. The single glass transition temperature reflects homogeneity at the molecular level. An additional consequence of this homogeneity is that statistical copolymers, such as those of styrene and butadiene, when viewed by electron microscopy, display a single phase morphology with no microphase separation. By contrast, block and graft copolymers of styrene/butadiene, for example, are characterized by two glass transition temperatures and separation into styrene-rich domains and butadiene-rich domains. It should be noted that membranes of the invention which are produced from statistical copolymers originally having a single glass transition temperature and a single phase morphology do not necessarily exhibit a single phase morphology or a single glass transition temperature after sulfonation because of chemical changes in the polymer effected by the sulfonation, in combination with the physical changes effected by the casting processes of the invention.

Pseudo-random copolymers are a subclass of statistical copolymers which result from a weighted change in the monomer incorporation that skews the distribution from a random arrangement (i.e., Bernoullian) is defined as statistical. Linear arrangements have been described here, but branched or grafted including star arrangements of monomers are possible as well. In addition, block copolymers of styrene and hydrogenated butadiene, isoprene, or equivalent olefin can be employed. The block architecture can be monomeric units comprising diblock, triblock, graft-block, multi-arm starblock, multiblock, segmented, tapered block, or any combination thereof.

One particular advantage provided by certain embodiments includes the ability to apply the disclosed process to non-styrenic high molecular weight polymers. Thus, in certain embodiments disclosed herein, the molecules utilized in the processes disclosed do not comprise a mono alkene—arene moiety or segment, such as a styrene segment. In certain other embodiments disclosed herein, polymers utilized in the processes disclosed do not contain poly alkene—arene moieties or segments, such as polystyrene. In certain such embodiments, the polymer includes moieties or segments comprising unsaturated carbon-carbon double bonds, which are able to be sulfonated. Some examples of such polymers include, but are not limited to polybutadiene or polyisoprene. With certain molecules that are highly reactive in a particular solution, the reaction conditions may be further altered by, e.g. lowering the reaction temperature and/or further cleaning the sulfonated polymer in order to remove residual solvent and/or undesirable by-products.

In particular, certain embodiments disclosed herein relate to the sulfonation of molecules comprising one or more of the following moieties: alkane, alkene, alkyne, and arene, each of which may be optionally substituted by one or more of the following functional groups: carboxylic acid, urea, ester, urethane (carbamate), alkene, amide, benzene, pyridine, indole, carbonate, thioester, arcylate/acrylic, ether, amidine, ethyl, acid versions of aliphatic compounds that contain alkenes, alkanes or alkynes, imidazole, oxazole, and other possible combinations of heteroatom containing groups susceptible to loss of water and/or disassembly. Each of the terms listed above has its standard definition known to one skilled in the art.

Some specific examples of molecules or molecule moieties or segments that may be utilized by the processes disclosed herein include but are not limited to polyethylene (PE), polypropylene (PP), polyethylene oxide (PEO), polystyrene (PS), polyesters, polycarbonate (PC), polyvinyl chloride (PVC), nylon, halogenated polymers or copolymers such as perfluorinated copolymers, poly(methyl methacrylate) (PMMA), acrylonitrile butadiene styrene

(ABS), polyamide (PA), polytetrafluoroethylene (PTFE), polylactic acid (PLA), polyvinylidene chloride (PVDC), styrene-butadiene rubber (SBR), styrene-ethylene/butylenes-styrene (SEBS); styrene-ethylene/propylene-styrene (SEPS), ethylene-styrene interpolymer (ESI), styrene acrylate, polyetherether ketone (PEEK), polyethylene terephthalate (PET or PETE), and any combination of these or others.

### Solvents

The solvent(s) used in the sulfonation reaction are preferably any solvent that does not react during the sulfonation process, is easily handled in commercialization processes, and offers the appropriate solubility characteristics for the molecule undergoing sulfonation and/or the final sulfonated molecule. In certain embodiments, the solvent is preferably anhydrous.

In certain instances, the non-reacting or inert solvent comprises a hydrocarbon, preferably a halogenated hydrocarbon, such as a chlorinated hydrocarbon solvent. Some examples include, but are not limited to ethylene dichloride, perchloroethylene, trichloroethylene, 1,1,1-trichloroethane (1,1,1-TCA), dichloroethane (including 1,1-dichloroethane (1,1-DCA), and 1,2-dichloroethane (1,1-DCE)), carbon tetrachloride, vinyl chloride (VC), tetrachloroethane, chloroform (trichloromethane), dichloethane, methylene dichloride (MDC), tetrahydrofuran (THF), dimethylformamide (DMF), dimethylacetamide (DMAC), or any combination of these. In addition to chlorinated hydrocarbon solvents, other non-reacting solvent(s) include but are not limited to carbon disulfide, nitro compounds, and super-critical carbon dioxide (which behaves as a supercritical fluid, under certain conditions, and any combination of these or other non-reacting solvents.

Certain embodiments of the process disclosed herein allow for a range of the amount of solvent(s) used in the sulfonation reaction. For example, in certain embodiments, the solvent ranges from 30-99.9% of the reaction solution. In other embodiments, the solvent ranges from 50-99.5% of the reaction solution. In still other embodiments, the solvent ranges from less than approximately 10%, 8%, 5%, 4%, 3%, 2%, or 1% by weight of the polymer solution. In other particular embodiments, the solvent ranges from less than approximately 8%, 7%, 6%, 5%, 4%, 3%, 2%, or 1% by weight of the sulfur trioxide.

While the disclosed process allows for a range of molar concentrations or percent solids, one of the limiting factors is the ease of handling the reaction mixture. For example, if the solution becomes too viscous (for example, when the solids concentration is too high), homogenous dispersion of the reaction components throughout the solution may be prevented. A solution that is too viscous, presents a potential for (localized) overheating, or non-uniform heating during the reaction.

The solution viscosity of any particular sulfonated molecule (including a polymer) may be varied over a wide range and will depend on a number of variables. One of the variables is the molecular weight of the molecule, other variables include the (polymer) solids concentration used in the reaction solution, the target/final sulfonation level of the sulfonated molecule product, the solvent(s) of choice, and the temperature of the reaction mixture. By controlling the molecule solution viscosity at the outset, the very fast sulfonation kinetics can alleviate many of the aforementioned problems, such as superheating, from occurring. Thus, the proper tailoring of the reaction parameters are important for achieving a uniformly sulfonated molecule product (which provides for improved precision in polymer sulfonation). Proper tailoring of the reaction variables at the onset may allow for the application of a polymer system that allows for a range of miscibility. Additionally, the proper tuning of the reaction variables in order to maintain fast reaction kinetics can allow for production of a sulfonated molecule that is insoluble in the non-reacting solvent(s).

One advantage provided by several of the embodiments disclosed herein includes the ability to reuse or recycle the solvent(s) that are during the course of the sulfonation reaction. Because sulfonation with acetyl sulfate presents a heterogeneous reaction mixture that includes organic, mineral and organic acid, as well as aqueous components, re-capture of pure solvent following the sulfonation reaction is cumbersome and prohibitively expensive. Thus, in order to reuse the solvent(s) of the processes described herein following moderated sulfonation using the sulfur trioxide reagent as described, the solvents are captured as the sulfonated molecule product is dried, immediately following sulfonation. As the solvent(s) can be easily reused for other sulfonation reactions solvent and disposal costs can be reduced as the only waste is associated with the a small amount lost during the sulfonated molecule drying step.

For example, mixing the complete output of the sulfonation reaction (where the polymer or other molecule may or may not be in solution) with one or more non-solvent(s) of the polymer or other molecule may capture the solvent. Following precipitation of the molecule, the solvents may be collected by filtration or other methods. Generally, non-polar aliphatic hydrocarbons, which lack ionizable hydrogen atoms, are well-suited non-solvents. Some examples include, but are not limited to alkanes, such as heptane, and hexane, or cyclic alkanes, including cyclopentane, cyclohexane, cycloheptane, and cyclooctane, which are relatively non-polar. Other suitable non-solvents can be readily ascertained by one of skill in the art without undue experimentation.

The solvent(s) are then removed from the sulfonated molecule reaction mixture, such as by decanting or filtering. In certain embodiments that use non-miscible solvents that may have similar boiling points, such as dichloromethane or pentane, the solvent may be separated by fractional distillation. The sulfonated molecule is then allowed to dry, whether by ambient air, drying oven, or desiccation. The final sulfonated molecule typically produces a dry powder or flake product.

### Electron Pair Donor Agent

Sulfur trioxide (SO₃) is a highly reactive electron acceptor or Lewis acid, and readily interacts with electron pair donors or Lewis bases to form coordination compounds, also referred to as “coordination adducts” or “coordination complexes” herein. Formation of a coordination complex with sulfur trioxide provides a method of regulating its reactivity, particularly in some of the embodiments of the sulfonation reactions described herein.

Without wishing to be bound by any particular theory, certain embodiments of the presently disclosed process benefit from the addition of an electron pair donor agent or blocking agent to the sulfonation reaction. One possible theory as to how the addition of an electron pair donor agent or blocking agent renders the sulfonation reaction more efficient is based on the attraction of the agent to the sulfur trioxide. This chemical interference may assist to regulate the sulfonation reaction as the sulfur trioxide reacts with the styrene or general aromatic ring of the polymer or other molecule. The addition of an electron pair donor agent or blocking agent produced the surprising result of enhancing the sulfonation process for large molecular weight or long chain molecules utilizing sulfur trioxide in the polymeric sulfonation reaction.

Typically, the electron pair donor agent utilized in the synthetic sulfonation scheme employing sulfur trioxide in the methods of process disclosed herein includes, but is not limited to, a bidentate electron pair donor agent which is soluble in a non-reactive organic solvent. In particular embodiments, the electron pair donor agent comprises an organic species comprising at least two hetero atoms separated by at least two other atoms (for example, representing a 1,4-arrangement of heteroatoms; a 1-5-arrangement of heteroatoms, or a 1-6-arrangement of heteroatoms,etc.). Some examples of electron pair donor agents that may be used with the present process include, but are not limited to cyclic or non-cyclic carboxylic acid esters, amines (including tertiary amines), sulfides, carboxylic acids, thiols, amides, ethers, thioethers, and sulfonamides. In certain embodiments, at least one electron pair donor agent comprises trimethylamine, triethylamine, pyridine, N,N′-diethylaniline, 42-methlypyridine, 2,6-dimethylpyridine, N-ethylmorpholine, 1,2-dimethoxyethane, 1,3-dimethoxypropane, 1,4-dioxane, or others.

As indicated in Example 1, one embodiment of the method or process of the invention includes adding sulfur trioxide to a solution of the electron pair donor agent dioxane in a chlorinated solvent. Sulfur trioxide-dioxane is relatively unstable, which requires that it usually be prepared immediately before use. The ratio of sulfur trioxide to dioxane may be varied within the optimal range of approximately 0.5 to 2 moles of dioxane per mole of sulfur trioxide. Thus, in certain embodiments the amount of the electron pair donor pair agent (including dioxane or 1,2-dimethoxyethane) per mole of sulfur trioxide is approximately 0.25, 0.5, 1.0, 1.5, 2.0, 2.5, or any value there between.

Typically, if less than approximately 0.5 moles of dioxane per 1 mole of sulfur trioxide is used in the sulfonation reaction, the reaction may occur too quickly (independent of the reaction temperature, which is addressed below), and undesirable side-products may form. Lowering the temperature (i.e. by further cooling the reaction mixture) to as low as −20° C. may not overcome formation of the undesirable side-products. Moreover, sulfonation slows dramatically if more than approximately 2.0 moles of dioxane per 1 mole of sulfur trioxide are used.

### Reaction Conditions

A feature of the methods or processes of the invention includes the surprising result of a controllable sulfonation reaction that results in a sulfonated molecule product with low levels, or the absence of, undesirable side-products or degradation. In contrast, even when very low temperatures are utilized for sulfonation reactions using uncomplexed sulfur trioxide, sulfonation leads to a complex mixture of sulfonated molecule product and a variety of undesirable side reactions. Typically, dehydrogenation and oxidation accompany sulfonation, and the end product contains complex mixtures of hydroxyl and carbonyl compounds, carboxylic acids, and unsaturated compounds, as well as their derived sulfates, sulfonic acids, sulfones, sultones and sulfonate esters. It is expensive and cumbersome to purify the sulfonated molecule in the presence of these undesirable sulfonation reaction side-products.

Several factors contribute to the efficiency of the sulfonation processes disclosed herein, including, but not limited to, the sulfonating agent, the molecule, the molecular weight of the molecule, the solvent, the concentration of reactants in the sulfonation solution, the rate and amount of agitation or mixing, the purity of the solvent and reactants, the temperature of the reaction and reactants, the molar ratios of reactants, solvent(s) and optional electron pair donor agent(s), the modes of reactant feeding, the size of the sulfonation vessel, the sequence of addition to the solution of each of the reactants, the aging of the finished reaction mixture, and others.

In some embodiments, the concentration of the molecule utilized in the sulfonation reaction solution is less than approximately 50% solids, less than approximately 40% solids, less than approximately 30% solids, less than approximately 20% solids, less than approximately 10% solids, less than approximately 5% solids, less than approximately 4% solids, less than approximately 3.5% solids, less than approximately 3% solids, less than approximately 2% solids, less than approximately 1% solids, less than approximately 0.5% solids, or less or any value there between. In some particular embodiments, the concentration of the molecule utilized in the sulfonation reaction solution is in the range of approximately 2-5% solids. In still other particular embodiments, the concentration of the molecule utilized in the sulfonation reaction solution is approximately 3.5% solids.

In certain embodiments disclosed herein, the concentration of at least one electron pair donor agent is at least approximately 1.0 mol % donor molecule per mole of sulfur trioxide. In other embodiments, the concentration of at least one electron pair donor molecule is at least approximately 2.0 mol %, 3.0 mol %, 4.0 mol %, 5.0 mol %, 6.0 mol %, 7.0 mol%, 8.0 mol%, 9.0 mol %, 10 mol %, 20 mol %, 30 mol %, 40 mol %, 50 mol %, 60 mol %, 70 mol %, 80 mol %, 90 mol %, 100 mol %, 110 mol %, 120 mol %, 150 mol %, 175 mol %, 200 mol %, 225 mol %, 250 mol %, 275 mol %, 300 mol %, 325 mol %, 350 mol %, or any value there between donor agent per mole of sulfur trioxide.

The various molecules that may be utilized in the sulfonation reaction disclosed herein may be exposed to the sulfonating reagent in the form of a solid, liquid, or gas (including vapor). The molecular species or sulfonating reagents may be completely or partially soluble in the reaction medium such that the reaction medium comprises a solution, mixture, gel, emulsion, colloidal suspension, sol, or the like or any combination thereof. In some particular embodiments, the molecule is introduced into the sulfonation reaction in a solid form, including the form of pellets, crumb, chunks, flat sheets, dispersed particles, or the like. In other embodiments, the molecule is introduced to the sulfonation reaction in liquid form (in solution or in mixture form) with the other reaction components. Still, in other particular embodiments, the molecule is introduced to the sulfonation reaction in a gaseous or vapor form. In some embodiments, the molecule is introduced into the sulfonation reaction in any combination of these forms.

The degree of sulfonation is defined in the art as the quotient of the total number of sulfonic acid groups in the molecule and the total number of self-repeating monomeric units. Adjusting one or more of the several factors that contribute to the efficiency of the sulfonation process described herein may regulate the degree of sulfonation. For example, by increasing or decreasing the temperature beyond the preferred range, the sulfonation reaction slows and the resulting sulfonated molecule exhibits a low percent by weight of sulfonic acid residues. Moreover, by increasing or decreasing the speed beyond the preferred range, the molecule may precipitate out of solution and the resulting sulfonated molecule is not uniformly sulfonated.

As described inter alia, the degree of sulfonation of a particular molecule disclosed herein may range from approximately 2-100 mole mol %. Preferably, the sulfonated molecules disclosed herein exhibit a degree of sulfonation of approximately 10 mol %, 20 mol %, 30 mol %, 40 mol %, 50 mol %, 60 mol %, 70 mol %, 80 mol %, 90 mol %, 95 mol %, 96 mol %, 97 mol %, 98 mol %, 99%, 100 mol %, or any value there between. Most preferably, the sulfonated molecules disclosed herein exhibit a degree of sulfonation of approximately 25% to 80%.

Certain embodiments of the disclosed process are characterized by a low reaction temperature and short reaction time. Using a low temperature results in a highly efficiently sulfonated product molecule that exhibits a desirable and controllable degree of uniform sulfonation with little to no generation of undesirable side-products. In certain embodiments, the starting temperature of the reactants and/or the temperature of the reaction mixture and/or the temperature of the sulfonation reaction is approximately −40° C., −30° C., −25° C., −20° C., −15° C., −10° C., −5° C., 0° C., 5° C., 10° C., 15° C., 20° C., 25° C., 30° C., or any value there between. The starting temperature or reaction temperature or sulfonation temperature may all be the same or each temperature may be different. For example, the starting temperature may be approximately −20° C., and increase slightly as the reaction mixture is mixed or processed due to the increase in kinetic energy. Furthermore, the sulfonation reaction itself may be exothermic, thus increasing the reaction temperature.

The lower limit for the temperature of the reaction mixture during the reaction is chosen such that a relatively uniform liquid is still present, i.e. such that no component of the mixture is present as a solid aggregate. While the reaction temperature ranges may vary somewhat, the sulfonation reaction slows at colder temperatures, while degradation of the molecule may occur and/or formation of undesirable reaction side-products (such as crosslinking) occurs at temperatures that are too high.

In addition, the sulfonation process can be carried out either under normal pressure or under increased pressure. Overall pressure is preferably in the range of approximately 1-200 bar. In certain embodiments, the pressure is approximately 1 bar, 5 bar, 10 bar, 20 bar, 50 bar, 75 bar, 100 bar, 120 bar, 150 bar, 180 bar, 200 bar, or any value there between.

Another surprising result of the presently disclosed process relates to using the thermo-kinetic effect of the high speed mixer wherein the shear rate is from approximately 5 s⁻¹, 10 s⁻¹, 15 s⁻¹, 20 s⁻¹, 30 s⁻¹, 40 s⁻¹, 50 s⁻¹, or greater or any value there between that is capable of increasing the temperature of the sulfonation reaction in a controlled and uniform manner. It was found that when the temperature of the sulfonation reaction is uniformly increased, the reaction results in a more uniformly sulfonated molecule. Moreover, when the sulfonation reaction is conducted at very low temperatures (such as −20° C.), the kinetic energy of the high speed mixing or agitating environment operates to initiate the sulfonation reaction.

Sulfonation reactions that take place in a high speed mixing or agitating environment typically prevent the molecule from settling and/or precipitating out of the solvent. As one of skill in the art would recognize, the speed that is needed to prevent the molecule from precipitating out of the solvent may vary depending on the particular equipment (such as a spinning plate thin film reactor, or a counter-rotating shaft thin film reactor) used for the sulfonation reaction. Thus, the high-speed mixer assists in maintaining the reaction components in solution or dynamic mixture and prevents the sulfonated molecule from aggregating.

The sulfonation reaction process may further be varied by the sequence in which the reactants are added to the reaction mixture or solution. In certain embodiments, the sulfonation reaction components may be added in any order or simultaneously. In other embodiments, the molecule is dissolved in or otherwise placed in contact with one or more non-reactive solvent(s) prior to contact with sulfur trioxide and/or the optional electron pair donor agent(s). In other particular embodiments, the non-reactive solvent may be first placed in contact with sulfur trioxide and/or the optional electron pair donor agent(s) prior to adding the molecule. In still other particular embodiments, the molecule may be placed in contact with sulfur trioxide and/or the optional electron pair donor agent(s) prior to addition of the non-reacting solvent. Thus, in certain embodiments, the sulfur trioxide utilized in the processes disclosed herein is present in the reaction in the form of free sulfur trioxide. In certain other embodiments, the sulfur trioxide utilized in the processes disclosed herein is present in the reaction in the form of a coordination complex with at least one electron pair donor agent. In some particular embodiments, the non-reacting solvent is capable of forming a coordination complex with the sulfur trioxide.

Depending on several factors, including the starting molecule and the degree of sulfonation desired, as well as the overall sulfonation reaction kinetics, the sulfonation reaction can be completed within the range of approximately 5 to 2000 seconds (or approximately 33 minutes). In certain embodiments, the reaction kinetics allow for the reaction to be completed within approximately 1 second, 2 seconds, 3 seconds, 4 seconds, 5 seconds, 10 seconds, 20 seconds, 30 seconds, 40 seconds, 50 seconds, 60 seconds, 70 seconds, 80 seconds, 90 seconds, 100 seconds, 120 seconds, 140 seconds, 160 seconds, 180 seconds, 200 seconds, 300 seconds, 400 seconds, 500 seconds, 600 seconds, 800 seconds, 1000 seconds, 1500 seconds, 2000 seconds, or any value there between. In certain embodiments, the sulfonation reaction takes no more than approximately 6 hours, 5 hours, 4 hours, 3 hours, 2 hours, 1 hour, or a half hour. In certain embodiments, the reaction is complete within approximately two minutes or less, one minute or less, or 30 seconds or less, or any value there between.

The sulfonation reaction can be terminated by exhausting reaction components, or quenching by the addition of water or other sacrificial reactant (such as ethanol or methanol), which converts sulfur trioxide to an ester of sulfuric acid, and ceases sulfonation of the polymer. In addition it is possible to terminate the reaction by selecting and adding a solvent capable of separating the sulfonated molecule from the reaction system.

Once the sulfonation reaction has been terminated, the sulfonated molecule may then be isolated by filtration, precipitation, chromatography, or other purification methods known in the art. The sulfonated molecule may be washed (if necessary), by standard techniques known in the art. For example, the sulfonated molecule may be washed by submersion in a washing liquid (including but not limited to deionized water or an aqueous salt solution) followed by filtration, or spray washed on a film evaporator. The aqueous salt solution may be preferable, if the sulfonated molecule is not required to be in acid form.

The molecule may then be dried at room temperature, or elevated temperature, under vacuum pressure.

As disclosed herein inter alia, another beneficial feature of the disclosed process includes the cost-savings ability to recycle the sulfonation reaction solvent(s) and optional electron pair donor agent(s). As described herein, the electron pair donor agent does not chemically participate in the sulfonation reaction. Thus, it can be easily removed from the sulfonated molecule at the termination of the sulfonation reaction. In the case of dioxane, residual traces evaporate from the precipitated sulfonated molecule during the drying step. The ability to reuse or recycle the solvent(s) and/or electron pair donor agent(s) of the presently disclosed process makes the processes disclosed herein amenable to use a multitude of molecules in a wide variety of applications.

In addition to batch processing, the presently disclosed methods of sulfonating molecules may be utilized for large scale sulfonation of molecules by utilizing a continuous feed process, i.e. an industrial scale apparatus that moves the molecule to be sulfonated continuously through a sulfonating reaction mixer and into a holding tank once sulfonated. In this regard, the throughput of the process is increased by several orders of magnitude. Such a large-scale process increases yield, lowers cost, and produces more uniform sulfonated molecules, all of which make it readily adaptable for commercialization.

### Sulfonated Molecules

Previously used processes for sulfonating molecules, such as polymers, with sulfur trioxide resulted in high levels of cross-linking polymers and high levels of undesirable side-products. (U.S. Pat. Nos. 2,475,886; 2,283,236; and 2,533,211, all of which are hereby incorporated by reference in their entirety).

The sulfonated molecules generated by the disclosed process include sulfonated and/or polysulfonated nucleic acids (nucleotides), amino acids, peptides, polypeptides, proteins, glycoproteins, biopolymers, oligomers and/or polymers and/or copolymers containing either alkene and/or arene and/or hydroxyl moieties with little or no residual or contaminating sulfuric acid remaining following removal of water from the solvent(s). In certain embodiments, the sulfonation reaction is performed under an anhydrous and controlled atmosphere, which may include inert gases such as argon, nitrogen or the like. Depending on the particular starting material, the sulfonated molecules generated (such as a sulfonated ionomeric copolymer) may be soluble in water, or insoluble in water but soluble in alcohol (for example n-propanol or butyl alcohol or any variety of binary, ternary or higher solvent mixtures).

Additionally, the sulfonated molecules generated by the processes disclosed herein will have little, if any, cross-linking polymeric components or other undesirable side-products. In embodiments that utilize an ionomeric copolymer in the sulfonation reaction there will be little or no resulting cross-linked ionomeric copolymer(s).

Furthermore, the sulfonated molecules generated by the disclosed process are highly uniformly sulfonated or polysulfonated. In certain embodiments, the sulfonated molecule is uniformly sulfonated or polysulfonated from approximately 20%, 30%, 40%, 50%, 60%, 70%, 80%, 85%, 90%, 91%, 92%, 93%, 94%, 95%, 96%, 97%, 98%, 99% by weight, or greater or any value there between. In certain embodiments, the sulfonated molecule prepared by the disclosed process is uniformly sulfonated or polysulfonated at 10-90% by weight.

Uniformly sulfonated molecule membranes (such as sulfonated polymer membranes) typically have higher ionic conductivities, higher water transfer rates, and reduced water absorption at lower sulfonation mole percent conversion levels than non-uniformly sulfonated molecule of the same chemical structure. Thus, one of skill in the art would infer uniformity of a particular sulfonated molecule based on several molecule mechanical and electrochemical properties, as demonstrated for the highly uniformly sulfonated molecules disclosed herein. Some of these properties are examined in the polymers disclosed in the Examples section herein.

The method of sulfonating arene-containing molecules and the various sulfonated molecules disclosed herein may be used directly or further modified before use. For example, the sulfonated molecules disclosed herein may be used as the free acid or as a salt thereof such as that of an alkali metal, or other metal salt thereof, including but not limited to metal ions, preferably mono-, di- and trivalent ions of metals in Groups IA, IB, IIA, IIB, IIIA, IIIB, and VIII of the Periodic Table of Elements. The metal ions may be complexed or uncomplexed, and can be used alone or in any mixture thereof. Some examples of suitable metal ions include: lithium, sodium, potassium, rubidium, silver, mercury, copper, magnesium, calcium, strontium, cadmium, tin, iron, barium, palladium, scandium, yttrium, and cesium salts, or any combination thereof. Compounds of these metals may be used as hydroxides, chlorides, bromides, fluorides, oxides, alcoholates, hydrides, carboxylates, formates, acetates, alkoxides such as methoxides or ethoxides, nitrates, carbonates, bicarbonates, and the like.

The degree of neutralization with a metal ion-containing base may be achieved by various methods known in the art. In particular, the neutralization reaction may be carried out by adding the metal compound, directly or in solution, to a solution of the sulfonated molecule and, following neutralization, precipitating and separating the resulting molecule. Another particular method of neutralization may entail melt blending the sulfonated molecule with the metal compound. This reaction is preferably conducted at elevated temperatures in order to facilitate homogenous distribution of the metal compound and to volatize the neutralization product that can include water, alcohols, and small organic species.

Alternatively, the sulfonated molecule may already be in an all neutralized salt form or in a partially neutralized form and protonation (acidification) is desired. Acidification of the sulfonated molecule may be carried out under conditions, which allow for a homogenous uniform distribution of the acid in the sulfonated molecule. The resulting metal-salt acidification product may then be used directly or treated further in order to remove any metal salt by-product.

The degree of sulfonation and/or neutralization may be measured by several techniques that are readily available to the skilled artisan. For example, nuclear magnetic resonance (NMR), titration, or elemental analysis may be used to determine the overall degree of functionality. Moreover, the sulfonated molecules may be analyzed for sulfonation and other characteristics by using Fourier Transform Infrared spectroscopy or other technique in conjunction with optical spectroscopy, infrared spectroscopy, nuclear magnetic resonance, electron spin resonance and others. In addition, the titration of a solution of a block copolymer with a strong base may be utilized to determine the degree of functionality and/or neutralization (metal sulfonate salt content). Neutralization is generally based on the percentage of sulfonate ions as compared to the total sulfonic acid and sulfonate group functionality.

Moreover, compositions and articles prepared by the sulfonated molecules disclosed herein may also contain non-reactive additives, such as chemical additives, fillers, or reinforcements, which do not react with the sulfonated molecule. Some examples include, but are not limited to plasticizers, lubricants, anti-oxidants, anti-static agents, colorants, flame retardants, fillers, mold release agents, nucleating agents, stabilizers or inhibitors of oxidative, thermal and ultraviolet light degradation, and fibrous or other reinforcements (including but not limited to silica, carbon black, clay, glass fibers, organic fibers, calcium carbonate, and the like).

The sulfonated molecules disclosed herein may be further modified before use by processes, such as cross-linking, that improve their mechanical properties. Examples of suitable methods for cross-linking polymers are taught by U.S. Pat. Nos. 6,841,601 and 7,179,860, both of which are incorporated herein by reference in their entireties.

In other embodiments the molecule to be sulfonated may be preformed or cross-linked, or a combination of the two prior to sulfonation. For example, a cross-linked bead of styrene-divinyl benzene copolymer may be subjected to sulfonation to yield an ion-exchange bead or may be insoluble in the sulfonation solvent medium thus resulting in sulfonation of the surface. For example polyethylene terephthalate or parylene may be sulfonated by the sulfonating complex without the aggressive and degradative affects of neat sulfur trioxide.

In certain embodiments disclosed herein, the sulfonated molecule have a total mole percent (mol %) sulfonation of approximately 2-99% or greater. In specific embodiments, the mol % of sulfonation is approximately 2%, 5%, 10%, 20%, 25%, 30%, 40%, 50%, 60%, 70%, 75%, 80%, 90%, 91%, 92%, 93%, 94%, 95%, 96%, 97%, 98%, 99%, 99.5%, or greater or any value there between. The mole % of sulfonation may be varied during the process to produce from 5-99% sulfonation. The sulfonated molecules disclosed herein exhibit exceptionally good qualities. Depending on the particular starting material, qualities such as toughness, clarity, formability, oil/grease resistant barrier, draw ability, heat seal, hot tack, abrasion resistance, electrical conductivity, tensile strength, stiffness, hardness, tensile impact, stress crack resistance, adhesion, durability, and melt strength are enhanced by the sulfonation process disclosed. The sulfonated molecules may be used for sizing agents, protective colloids, adhesives, dispersing agents, thickening agents, tanning agents, packaging resins, conventional extrusion/co-extrusion blown film, cast film, other films, extrusion coating equipment, molding resins, automotive parts, golf ball resins, packaging seals, molded goods (e.g. cosmetics, or sporting goods), and may be used for electro spraying or electro spinning in the form of a fiber, foam, sheet, or encapsulate, or any combination thereof.

In certain embodiments, membranes may be produced utilizing the sulfonated molecules disclosed herein by spray processing, such as thermal spray coating. Thermal spray processing allows for a relatively thin (approximately 0.005″) and thick (approximately 0.250″) coatings of polymers onto a variety of materials and is effective to produce protective barriers. Some examples of polymers that have been used for thermal spraying include but are not limited to polyethylene, polymethyl-methacrylate, ethylene-methyl methacrylate copolymer, ethylene methacrylic acid copolymer, polyetheretherketone polymer, polyphenylene sulfide liquid crystal polymer, nylon, phenolic epoxy, Tefzel, and post consumer commingled polymer.

In general, the molecule powder is injected into a heat source (such as a flame or plasma) and moved to a pre-heated substrate by way of a spray gun or other apparatus. The thickness of the coating depends on the number of passes of the spray gun across the substrate.

In still other embodiments, membranes may be produced utilizing the sulfonated molecules disclosed herein by melt extrusion. Generally, melt extrusion involves feeding molecules into a drive extruder as raw plastic material, which transports the material to a die head while it is simultaneously heated, mixed, pressurized and metered. At the die head, the molecule takes up the approximate shape of the article and is then cooled either by water or air to give the final shape. As the molecule cools it is drawn along by haul-off devices and either coiled (for soft products) or cut to length (for hard products).

In addition to the above-mentioned processes, membranes may also be produced using sulfonated molecules disclosed herein by using a rotogravure process or a slot casting process. For a slot casting process, the molecule dissolved in a solvent is pressure extruded in a uniform thickness and viscosity onto carrier or support creating a continuous film. Rotogravure is a process wherein a cylinder with surface cavities is coated with a liquid. As the cylinder turns, it transfers the liquid in the surface cavities to a carrier or support forming a continuous film. Generally, uniformly sulfonated polymer casts evenly with little or no signs of macro-phase separation. When membrane casting is even, it produces stronger membranes because the density and cross-sectional thickness are uniform.

The sulfonated molecules disclosed herein may be used in a variety of industrial settings and for a variety of applications. One of skill in the art could adapt or modify the sulfonated molecules described herein in order to be included in a variety of application. Further embodiments of the present invention include processes for manufacturing various articles or compositions by utilizing the sulfonated molecules described herein.

One of skill in the art would fully appreciate that the various articles may be further processed or have any number of other components present, including other sulfonated molecules or unsulfonated molecules. For example, certain articles may comprise a therapeutic or other agent including but not limited to antimicrobial agents (such as antibacterial, antifungal, antiviral, spermicide, antiparasitic or other agent), anesthetics, growth factors, anti-inflammatory agents, antihistamines, analgesics, anti-neoplastic agents, hormones, tranquilizers, metals, vitamins, minerals, amino acids, nucleic acids, cytokines, and the like). In certain embodiments, such as for use of the sulfonated molecules as membranes, it may be necessary that any such additive be miscible with the sulfonated molecule, not compromise the mechanical strength or integrity of the membrane, and/or not reduce the moisture transfer of the membrane.

Thus, for certain embodiments, the sulfonated molecules may be molded, dipped, fiber spun, extruded or otherwise processed into articles. The articles may take the form of a film, sheet, coating, band, strip, profile, molding, foam, tape, fabric, thread, filament, ribbon, bead (including microbeads and nanobeads), other spheres (including microspheres and nanospheres), knit, weave, fiber, plurality of fibers, fibrous web, or any combination thereof. Any of these forms may be solid, perforated, laminated, woven, non-woven, porous, non-porous, or the like and any combination thereof. In addition, the sulfonated molecules may be utilized in various durable or consumable goods.

For example, the sulfonated molecules disclosed may be used in various forms in the textile industry (such as for spinning fibers, fabrics, or polymeric blends); or in leather tanning (for example, for coating leather articles). The sulfonated molecules may be combined with any natural or synthetic fabric, including but not limited to polyester fabric, poly(ethylene terephthalate) fabric, rayon fabric, acrylic fabric, polymeric fabric, cotton, jute, silk, wool, linen, twill, toile, bunting, duck, faille, gabardine, herringbone, jacquard, muslin, lawn, leno, paper or plant based fabrics, or others. Some examples of articles that may be manufactured from the sulfonated molecules include clothing (including but not limited to shirts, jackets, pants, shoes, boots, socks, hats, bodysuits, gloves, head coverings, hazardous material protective clothing, goggles, etc.), blankets, rugs, furniture, carpeting, other floor coverings, and the like.

The sulfonated molecules may be used for various applications in healthcare. Examples of some such articles are taught by PCT/US2005/024593 (WO 2006/017245), U.S. Pat. Nos. 5,840,387, and 6,306,419; as well as U.S. application Ser. No. 10/691117 (published as U.S. Application Publication No. 20040142910), all of which are hereby incorporated by reference in their entireties.

Specifically, in certain embodiments, the sulfonated molecules may be adapted for use in surgery or other articles related to medical intervention for diagnosis, treatment, or prevention of disease or a biological disorder. For example, tissue engineering; artificial neuron fibers; medical or dental cement; drug delivery formulations; pharmaceutical compositions; implantable medical devices such as stents, catheters, cannulae, tubing, shunts, vascular grafts, artificial organ surfaces (such as heart, kidney, liver, pancreas, or other organ), heart valves, pacemakers, kidney dialysis, implants, artificial joints, contact lenses, assist device surfaces, including prostheses, or various other implantable devices or surfaces, wound dressings (such as gauze dressings, bandages, sutures, and the like).

In certain embodiments, the sulfonated molecules disclosed herein may be adapted to for use as equipment coatings; adhesives, fluid absorbing materials, including bodily-fluid absorbing materials (such as internal or external pads, tampons or other material for use as disposable diapers, urinary incontinence products, feminine hygiene products, lactation or nursing products, and the like); IV bags, blood bags, medical articles, such as hospital gowns, laboratory wipe, surgical drapes, bedding, protective scrubs or clothing; coatings on tables; countertops; floors; or laboratory equipment, etc.

The sulfonated molecules disclosed herein may further be used in various applications in occupational safety or homeland security, including polymer electrolyte membranes (PEMs); chemical or biological protection clothing, instruments or other articles; fluid treatment (for example, membranes for fluid or gas treatment including desalination or other filtration of water, filtration of blood or other bodily fluids, filtration of food or beverages, filtration of indoor or outdoor air, etc.), and the like. Sulfonated copolymers, as used in polymer electrolyte membranes, generally exhibit good electrical conductivity (J. Electrochem. Soc., 142: L21-L23 (1995)), low methanol crossover rate (J. Electrochem. Soc., 143: 1233-1239 (1996)); excellent thermal stability (J. Electrochem. Soc. 143: 1225-1232 (1996)); very low or nearly zero water drag coefficient (J. Electrochem. Soc. 143: 1260-1263 (1996)); as well as enhanced activity for oxygen reduction (J. Electrochem. Soc. 144: 2973-2982 (1997)). Accordingly, certain sulfonated polymers disclosed herein may be useful as polymer electrolyte membranes.

In certain other embodiments, the sulfonated molecules disclosed herein may be adapted for use in the electronics field, such as for electrochemical devices (including membranes for fuel cells or fuel devices, and batteries); in testing assays or sensors (including microfluidic devices, cell impedance sensors, moisture and/or heat transfer membranes, semiconductor chips or other computer parts, ultra-capacitors, other capacitors, other electronic sensors, or the like). Certain such embodiments are taught in U.S. Pat. Nos. 5,679,482; 5,468,574, 6,110,616, 6,413,298; and 6,383,391, which is hereby incorporated by reference in its entirety.

A fuel cell device generates electricity directly from a fuel source, such as hydrogen gas, and an oxidant, such as oxygen or air. A fuel cell typically comprises of two catalytic electrodes separated by an ion-conducting membrane. The fuel gas (e.g. hydrogen) is ionized on one electrode, and the hydrogen ions diffuse across the membrane to recombine with the oxygen ions on the surface of the other electrode. If current is not allowed to run from one electrode to the other, a potential gradient is built up to stop the diffusion of the hydrogen ions. Allowing some current to flow from one electrode to the other through an external load produces power.

In certain embodiments, the membrane made from the sulfonated molecules disclosed herein, is mechanically stable, allows the diffusion of ions from one electrode to the other while preventing the flow of electrons, and/or keeps the fuel and oxidant gases apart. Diffusion or leakage of the fuel or oxidant gases across the membrane leads to explosions or other undesirable consequences.

Certain other embodiments relate to utilizing the sulfonated molecules described herein for use with environmental control elements (such as for heating, ventilating, air conditioning, cooling, humidity control, etc.), and may include membranes, sensors, gauges, unitary humidity exchange cell (HUX), and the like.

The homogeneity of the sulfonated molecules disclosed herein make these products and processes particularly suitable for producing membranes for applications that require a high degree of uniformity of properties. Furthermore, the disclosed processes yield sulfonated molecules with a lower level of conversion to get the useful sulfonated molecule. Thus, in one example, the sulfonated molecules may be used to form ion conducting membranes, such as when cast from high dielectric constant solvents and are insoluble in water.

The sulfonated molecule used for certain membranes disclosed herein are preferably water-insoluble (having a solubility of less than 0.5 grams of polymer in 100 grams of water at 100° C.).

For example, HUX cells may comprise a membrane that is utilized for transferring water or other polar liquids or gases (including vapors) from one side of the cell to the other side of the cell by action of a difference in some quantity or gradient across the cell. This transfer of water or gas may or may not be accompanied by evaporation of the water or gas into or from the stream by the absorption of heat or diabatic means. The membrane gradient may be produced by vapor pressure, osmotic or hydrostatic pressure, chemical, thermochemical, electrochemical, magnetochemical potential difference, or thermal, electric, electromagnetic, thermoelectric, or electrothermal potential difference. Examples of applications of HUX include but are not limited to pervaporation, humidification and dehumidification of fuel cell streams in stacks and devices, drying gases at pressure, tertiary oil recovery, process control for chemical manufacture of chemicals for which water is a reactant, isolation of minerals from mining fluids, industrial separation of oil-water emulsions, microfiltration and ultrafiltration of colloidal suspensions and biological or organic macromolecules for purification, maintaining water content of methanol in direct methanol fuel cells, reverse osmosis for isolation of fresh water from brine, electrolysis cells, dialysis, electro-dialysis, piezo-dialysis, electro-osmosis and chloro-alkali cells.

Still other embodiments relate to adapting the sulfonated molecules disclosed herein for use as immersion coatings (such as for marine paints and coatings); other coatings (such as for drag reduction for cars, boats, aircraft, motorcycles or other motorized vehicles); consumable products (such as consumer electronics, appliances, toys, furniture, or packing materials); food and beverage industry (for example for cartons, containers, packaging, jars, boxes, food wrapping, or the like); outdoor articles (such as tents, soil coverings, tarps, recreational equipment, boating gear, lifevests, and the like); building materials or other composites, as well as other applications.

### Examples

### Example 1

Sulfonation of several styrene-alkene copolymers was conducted with the copolymers listed in Table I. Briefly, dioxane was added to an admixture of sulfur trioxide in dichloroethane. The solution contained a final ratio of approximately 0.5 moles dioxane per mole of sulfur trioxide. Moles of trioxide were calculated such that a particular mole percent of the aromatic moieties of the copolymers would be sulfonated by the sulfonation reaction.

The styrene-alkene copolymers were each admixed with dichloroethane to a concentration of approximately 2.5-5% solids (by weight) and the sulfur trioxide was added in the form of a coordination complex.

The reaction was maintained at temperatures between −10° C. to 10° C.

Prior to admixing to form the sulfur trioxide coordination complex, both the sulfur trioxide and dioxane were each cooled to a temperature of approximately −20° C. The atmosphere was not controlled for either the dissolution steps or the reaction steps. Thus, atmospheric water could influence the results as it can convert sulfur trioxide to sulfuric acid, which would not sulfonate the polymer.

Next, the sulfur trioxide-dioxane coordination complex and polymer were added simultaneously into a high speed stirring reactor and the solution cooled to approximately −5° C. during the mixing step. The resulting exothermic and high speed mixing process caused a temperature rise of the solution to approximately 0° C. within less than two minutes. After mixing the reaction (for approximately 90 seconds), an opaque sulfonated polymer solution resulted. The results are shown in Table I.

TABLE I

| Sample | | |
|---|---|---|
| ID | Polymer | % Sulfontion |
| AP-76-1 | ethylene/styrene statistical copolymer | 20.1 |
| AP-76-2 | ethylene/styrene statistical copolymer | 27.7 |
| AP-76-3 | ethylene/styrene statistical copolymer | 39.7 |
| AP-76-4 | ethylene/styrene statistical copolymer | 64.8 |
| AP-76-5 | ethylene/styrene statistical copolymer | 36.3 |
| AP-76-6 | ethylene/styrene pseudo random | 71.7 |
| | copolymer | |
| AP-76-7 | ethylene/styrene pseudo random | 39.0 |
| | copolymer | |
| AP-76-8 | ethylene/styrene pseudo random | 56.5 |
| | copolymer | |
| Ap-76-9 | ethylene/styrene statistical copolymer | 38.3 |
| AP-76-10 | ethylene/styrene statistical copolymer | 31.1 |
| AP-76-11 | ethylene/styrene statistical copolymer | 24.8 |
| AP-76-12 | ethylene/styrene statistical copolymer | 28.5 |
| AP-76-13 | ethylene/styrene statistical copolymer | 33.0 |
| AP-69-1 | styrene/ethylene/butylene tapered | 32.6 |
| | triblock copolymer | |
| AP-64-1 | styrene/ethylene/butylene tapered | 41.3 |
| | triblock copolymer | |
| AP-64-2 | styrene/ethylene/butylene tapered | 37.5 |
| | triblock copolymer | |
| AP-40-1 | styrene-co-methyl methacrylate | 26.2 |
| AP-30-1 | styrene isobutylene block polymer | 22.4 |
| AP-29-1 | styrene-(ethylene/butylene)-styrene | 54.5 |
| | triblock copolymer | |
| AP-DV-1 | Tecoplast aromatic polyurethane | <20% |
| AP-DV-2 | Polyethylene terephthalate | Surface Sulfonation |
| | | only* |

*No surface discoloration as observed with SO₃ treatment

The results generated were within the expected margin of error, indicating the stoichiometry of the reaction controlled the results.

### Example 2

In another exemplary embodiment, the styrene-alkene copolymers were each admixed with dichloroethane to a concentration of approximately 2.5-5% solids (by weight) was injected first in order to initiate high speed mixing.

The sulfur trioxide and dioxane dichloromethane solution (approximately 0.5 moles dioxane per mole of sulfur trioxide) was introduced at a feed rate that allowed the molar quantity of sulfur trioxide to produce a controlled level of sulfonation of the polymer without excess reagent. The mixing is typically carried out at −5° C. or lower.

Following the mixing step, the mixture is heated to bring the mixture temperature up to 15-20° C. in order to ensure the reaction has gone to completion. Next, the mixture is placed in a low speed precipitation tank where a solution non-solvent heptane was introduced. The non-solvent causes the sulfonated polymer to precipitate (typically as a granular or flake form) and the non-solvent and reaction solvent are filtered and pumped from the tank. Finally, the combined solvent and non-solvent mix is separated by boiling point and reused for other sulfonation reactions.

### Example 3

In another particular exemplary embodiment, the styrene-alkene copolymers were each admixed with anhydrous dichloromethane/under nitrogen to a concentration of approximately 2.5-5% solids (by weight) and then was injected a high-speed mixer.

The sulfur trioxide and dioxane dichloromethane solution (approximately 0.5 moles dioxane per mole of sulfur trioxide) was introduced under nitrogen at a feed rate that allowed the molar quantity of sulfur trioxide to produce a controlled level of sulfonation of the polymer without excess reagent. The mixing is typically carried out at −5° C. or lower. The nitrogen atmosphere was not broken during the reaction.

Following resonance for approximately 2-5 minutes, the contents of the mixer were transferred into a low speed precipitation tank where a solution recovered heptane was introduced and the sulfonated polymer was precipitated (typically as a granular or flake form) and the non-solvent and reaction solvent are filtered and pumped from the tank.

The dichloromethane solvent was recovered by stripping it from the combined solvent and non-solvent mix.

### Example 4

In still another exemplary embodiment, dichloromethane was distilled through a packed column by distillation before reusing, yielding 96% overall recovery.

The styrene-alkene copolymers were each admixed with recovered dichloromethane under nitrogen to a concentration of approximately 2.5-5% solids (by weight) and then was injected a high-speed mixer.

Dioxane was added to the recovered dichloromethane. The solution was cooled to −5 to 0° C. The sulfur trioxide was added, maintaining the temperature at 0° C. maximum. The nitrogen atmosphere was not broken during the reaction.

Following resonance for approximately 2-5 minutes, the contents of the mixer were transferred into a low speed precipitation tank where a solution non-solvent heptane was introduced. The non-solvent causes the sulfonated polymer to precipitate (typically as a granular or flake form) and the non-solvent and reaction solvent are filtered and pumped from the tank.

The wet sulfonated polymer was then transferred to a filtering funnel and dried under vacuum/pressure.

### Example 5

In still another exemplary embodiment, the styrene-alkene copolymers were each admixed with anhydrous dichloromethane under nitrogen to a concentration of approximately 2.5-5% solids (by weight) and then was injected a high-speed mixer.

The sulfur trioxide and dioxane dichloromethane solution (approximately 0.5 moles dioxane per mole of sulfur trioxide) was introduced under nitrogen at a feed rate that allowed the molar quantity of sulfur trioxide to produce a controlled level of sulfonation of the polymer without excess reagent. The mixing is typically carried out at −5° C. or lower. The nitrogen atmosphere was not broken during the reaction.

Following resonance for approximately 2-5 minutes, the contents of the mixer were transferred into a low speed precipitation tank where a solution recovered heptane was introduced and the sulfonated polymer was precipitated (typically as a granular or flake form) and the non-solvent and reaction solvent are filtered and pumped from the tank.

The dichloromethane solvent was recovered by stripping it from the combined solvent and non-solvent mix.

Following removal of the solvent, the polymer was filtered and dried at 30° C. under vacuum until dry.

The resulting sulfonated polymers were characterized by Fourier Transform Infrared spectroscopy and the spectrum was compared with standard known sulfonated polymer material. The sulfonation levels of the resulted polymers were obtained based on the styrene content from titration.

TABLE II
Test Data of Moisture transfer (M/T), Water uptake (W/U),
Ion conductivity (I/C), Gel Retention (G/R) and Hydraulic
stability (H/S) on the advance process samples

| Sample | Sulf. | M/T | W/U | I/C | G/R | H/S |
|---|---|---|---|---|---|---|
| ID | (%) | (g/10 min) | (%) | (S/cm) | (%) | (%) |
| AP-76-3 | 39.7 | 0.299 | | | | |
| AP-76-4 | 64.8 | 0.310 | | | | |
| AP-76-5 | 36.3 | 0.302 | | | | |
| Ap-76-9 | 38.3 | 0.276 | 436 | 0.1146 | 45.2 | 3568 |
| AP-76-10 | 31.1 | 0.249 | 140 | 0.0813 | 59.3 | 540 |
| AP-76-11 | 24.8 | 0.245 | 291 | 0.0837 | | 1097 |
| AP-76-12 | 28.5 | 0.265 | 479 | 0.0883 | | 1248 |
| AP-76-13 | 33.0 | 0.250 | 257 | 0.848 | | 1357 |
| AP-29-1 | 54.5 | 0.228 | 499 | 0.061 | | |

### Example 6

Preparation of several sulfonated polymers with sulfur trioxide was carried out according to the following Examples. The polymers utilized and results are listed in Table I and II herein.

Briefly, a ratio of 50 grams of a pseudo random ethylene styrene copolymer was dissolved in 1315 grams of dichloromethane in a stirred reactor kettle at room temperature, under nitrogen atmospheric pressure of 1 bar. The dissolution reaction was allowed to continue for several hours.

The sulfur trioxide/electron pair donor molecule coordination complex was prepared by using a charge of 260 grams of dichloromethane solvent at −5° C. under a nitrogen atmospheric pressure of 1 bar while stirring in a glass reactor. A charge of 25 grams of sulfur trioxide was dissolved in the dichloromethane solvent without breaking the nitrogen atmosphere in the glass reactor. Due to the low heat of solvation, the addition rate can be widely varied and still be successful. A charge of 24 grams of anhydrous 1,4-dioxane as the electron pair donor agent, was added to the glass reactor. In certain cases, the electron pair donor agent may have to be added slowly since it may cause an exothermic reaction with the sulfur trioxide.

The solution reaction temperature preferably remains at or below approximately 0° C. during the addition of the dioxane electron pair donor agent. The sulfur trioxide-dioxane mixture may become a viscous slurry. The temperature of the slurry is preferably held at approximately −5° C., or colder, and is kept under constant stirring.

### Example 7

The pseudo random ethylene styrene copolymer was reacted with the sulfur trioxide/dioxane mixture in order to sulfonate the polymer. Briefly, a high speed mixer was charged with dichloromethane at a temperature of 15° C. or colder, under nitrogen atmospheric pressure of 1 bar. The nitrogen atmosphere was not broken during the reaction. The polymer solution was simultaneously fed with the sulfur trioxide/dioxane mixture into the pre-charged high speed mixer.

Following resonance for approximately 2-5 minutes, the contents of the mixer were transferred into another reactor vessel containing 500 ml of stirred heptane under a nitrogen atmospheric pressure of 1 bar.

### Example 8

The dichloromethane solvent was recovered by stripping it from the reaction mixture under vacuum pressure, and at a temperature of 30° C. or colder. Following removal of the solvent, the polymer was filtered and dried at 30° C. under vacuum until dry.

The resulting sulfonated polymers were analyzed by Fourier Transform Infrared spectroscopy and the data was compared with standard known sulfonated polymer material. The data for sulfonation level of the sulfonated polymers is shown in Table II.

### Example 9

Membranes were produced according to standard procedures using the sulfonated polymers disclosed herein. The membranes disclosed herein were produced by slot casting the sulfonated polymers onto release liners on heated vacuum assisted casting tables. A release liner is vacuum adhered to a table that is flat and horizontal to within 0.005 inches across its surface. A charge of polymer solution is placed along one edge of the table. A casting blade takes the charge and distributes it across the release liner. The resulting film is of a uniform height because the blade edge is suspended above the surface creating a gap.

The moisture transfer of membranes produced with the sulfonated polymers disclosed herein was tested using a single cell moisture transfer procedure.

Briefly, the testing apparatus was set up as depicted in FIG. 1. The sample sulfonated polymeric membranes were placed in deionized water in the grooves of the apparatus shown in FIG. 2. Next, the temperature of the sulfonated polymeric membrane samples in the deionized chambers was adjusted to 30° C. The airflow meter was attached to an inlet of a flow manifold on the chamber, as shown in FIG. 3. The desiccant holding tube was filled with dried desiccant, as shown in FIG. 4. The weight of the dry desiccant was measured and the airflow was turned on at a rate of 1 liter per minute. The sample test was run for approximately 10 minutes, and the airflow was removed from the desiccant holding tube and the holding tube weight was measured. The difference between the weights of the desiccant holding tube prior to and subsequent to the 10-minute test was calculated as the moisture transfer value. The results are shown in Table II.

### Example 10

The water uptake of membrane samples produced using a sulfonated polymer disclosed herein was measured according to the following Example.

Briefly, each membrane sample was cut into the same size and dried to a constant weight at 80° C. The original dry weight of each dried membrane was measured. Next, the membranes were immersed in deionized water at a temperature of 20° C. for 15 minutes. Following this hydration step, each membrane was removed from the deionized water, excess water was removed and the hydrated weight of each membrane was measured. The % water uptake is calculated according to the difference between the hydrated weight and the original dry weight divided by the original dry weight×100.

Next, each membrane was allowed to air dry to a constant weight, and the air-dried weight of the membrane was measured. The % weight loss is calculated as the difference between the air-dried weight and the original dry weight divided by the original dry weight×100. The results are shown in Table II.

### Example 11

Ionic conductivity of membrane films generated from the disclosed sulfonated polymers was tested according to the following Example.

Briefly, each of the sulfonated polymers cast into a film was placed on a cell plate of a Schlumberger Impedance/Gain-Phase Analyzer Model number SL1260 using platinum foil electrodes and a machined plastic membrane clamp (which provided electrode contact pressure).

The thickness of the dry film was measured. Next, the film was hydrated in deionized water for 10 minutes and the thickness of the hydrated film was measured. Next, the wet film was placed on the side of the cell plate. Without allowing the film to dry, the film was sandwiched between the two cell plates. The entire assembly was placed into contact with deionized water and the film was tested on the Impedance Analyzer according to standard protocol.

Ionic conductivity was measured as 1.9 cm/((resistance)×(thickness in cm)×3.5 cm)). The results are shown in Table II.

### Example 12

Membranes produced with a sulfonated polymer disclosed herein were tested for gel retention ability. Briefly, each membrane was cut to the same size and thickness. Each membrane was then dried to a constant weight at 80° C. and the original dry weight was measured.

Next each membrane was submerged in normal propanol in a covered container. The membranes were allowed to remain freely submerged in the normal propanol for approximately 3 hours.

Following this, the swollen membranes were removed from the propanol by filtration and the swollen weight was measured. The membrane was then dried at 80° C. for approximately 15-30 minutes to a constant weight. The dried weight of the remaining residue was measured. The percentage of polymer residue following extraction was calculated by dividing the residue weight by the original dry weight×100. The results are shown in Table II.

### Example 13

The membranes produced from the sulfonated polymers disclosed herein were tested for mass loss by sulfonation by hot water extraction. First, the sample membranes were cut into the same size and briefly dried to a constant weight at 80° C. The original dry weight of each membrane was measured. Next, the membranes were hydrated in deionized water, followed by immersing in boiling deionized water for approximately 15 minutes.

The membranes were then removed from the boiling deionized water, excess water was removed, and the wet weight was measured. The percentage of boiling water uptake was calculated as the difference between the wet weight and the original dry weight divided by the original dry weight×100.

Next, the membranes were allowed to air-dry to a constant weight and the air-dried weight was measured. The percentage of weight loss was calculated as the difference between the air-dried weight and the original dried weight divided by the original dried weight×100. The results are shown in Table II.

All of the above U.S. patents, U.S. patent application publications, U.S. patent applications, foreign patents, foreign patent applications and non-patent publications referred to in this specification and/or listed in the Application Data Sheet, are incorporated herein by reference, in their entirety.

From the foregoing it will be appreciated that, although specific embodiments of the invention have been described herein for purposes of illustration, various modifications may be made without deviating from the spirit and scope of the invention. Accordingly, the invention is not limited except as by the appended claims.

1. A process for preparing a sulfonated molecule, the process comprising contacting a molecule with sulfur trioxide under suitable conditions to form a sulfonated molecule.

2. The process of claim 1 wherein the suitable conditions are selected from the group consisting of the presence of at least one inert solvent, the presence of at least one electron pair donor agent, a reaction temperature of between approximately −50° C. and 25° C., a reaction time of between 1 second and 30,000 seconds, mixing of between 500 rpm and 20,000 rpm, and a shear rate of between 5 s⁻¹ and 100 s⁻¹.

3. The process of claim 2 wherein the inert solvent is selected from the group consisting of ethylene dichloride, perchloroethylene, trichloroethylene, 1,1,1-trichloroethane (1,1,1-TCA), 1,1-dichloroethane (1,1-DCA), 1,2-dichloroethane (1,1-DCE), carbon tetrachloride, vinyl chloride (VC), tetrachloroethane, chloroform (trichloromethane), dichloethane, methylene dichloride (MDC), tetrahydrofuran (THF), dimethylformamide (DMF), and dimethylacetamide (DMAC).

4. The process of claim 3 wherein the inert solvent comprises methylene dichloride or dichloroethane.

5. The process of claim 2 wherein the reaction starting temperature ranges between approximately −25° C. and 20° C.

6. (canceled)

7. The process of claim 2 wherein the reaction time comprises between approximately 2 seconds and 20,000 seconds.

8. (canceled)

9. The process of claim 1 wherein the molecule is at least one selected from the group consisting of: a nucleic acid, an amino acid, a peptide, a polypeptide, a protein, a glycoprotein, a biopolymer, an oligomer, a polymer, and a copolymer.

10. The process of claim 1 wherein the molecule comprises a statistical, random, or block copolymer, oligomer, or polymer or any combination thereof.

11. The process of claim 10 wherein the molecule comprises a multiphase large copolymer, oligomer, or polymer, or any combination thereof.

12. The process of claim 1 wherein the molecule has a molecular weight of between approximately 100 grams/mole to approximately 500 grams/mole and contains at least one alkene or arene moiety.

13. The process of claim 12 wherein the molecule further comprises at least one moiety selected from the group consisting of: arene-containing linear side chains, non-arene-containing linear side chains, saturated linear side chains, unsaturated linear side chains, and flexible hydrocarbon linear side chains.

14. The process of claim 12 wherein the molecule comprises at least one monomeric unit selected from the group consisting of: polyethylene (PE), polypropylene (PP), polyethylene oxide (PEO), polystyrene (PS), polyesters, polycarbonate (PC), polyvinyl chloride (PVC), nylon, halogenated polymers or copolymers, poly(methyl methacrylate) (PMMA), acrylonitrile butadiene styrene (ABS), polyamide (PA), polyurethane, polytetrafluoroethylene (PTFE), polylactic acid (PLA), polyvinylidene chloride (PVDC), styrene-butadiene rubber (SBR), styrene-ethylene/butylenes-styrene (SEBS); styrene-ethylene/propylene-styrene (SEPS), ethylene-styrene interpolymer (ESI), styrene acrylate, polyetherether ketone (PEEK), and polyethylene terephthalate (PET or PETE).

15. The process of claim 2 wherein the electron pair donor agent is selected from the group consisting of: 1,2-dimethoxyethane, 1,3-dimethoxypropane, 1,4-dioxane, trimethylamine, triethylamine, pyridine, diethylaniline, 2-methlypyridine, 2,6-dimethylpyridine, N,N′-dimethyl ethylene diamine, and N-ethylmorpholine.

16. The process of claim 2 wherein the sulfur trioxide is present in the form of a coordination complex.

17. The process of claim 16 wherein the coordination complex comprises sulfur trioxide and the at least one inert solvent.

18. The process of claim 16 wherein the coordination complex comprises sulfur trioxide and the at least one electron pair donor agent.

19. The process of claim 18 wherein the at least one inert solvent comprises methylene dichloride, the reaction starting temperature comprises between approximately −20° C. and −10° C., the reaction time comprises between approximately 1 second and 1000 seconds, the molecule comprises at least one monomeric unit susceptible to sulfonation, and the electron pair donor agent comprises 1,4-dioxane.

20-21. (canceled)

22. The process of claim 1, further comprising admixing the molecule in at least one inert solvent and admixing the sulfur trioxide in at least one inert solvent prior to contacting the molecule with the sulfur trioxide.

23. A sulfonated molecule prepared by the process of claim 1.

24. The sulfonated molecule of claim 23 wherein the molecule is sulfonated from approximately 2 to 100 mole percent.

25. (canceled)

26. A disposable bodily fluid absorbing material comprising the sulfonated molecule of claim 23.

27. A surface coating comprising the sulfonated molecule of claim 23.

28. An environmental control unit comprising the sulfonated molecule of claim 23.

29. A pharmaceutical composition comprising the sulfonated molecule of claim 23.

30. A medical device comprising the sulfonated molecule of claim 23.

31. A medical article comprising the sulfonated molecule of claim 23.

32. A building material comprising the sulfonated molecule of claim 23.

33. A heat transfer membrane comprising the sulfonated molecule of claim 23.

34. A fluid transfer membrane comprising the sulfonated molecule of claim 23.

35. An ion conducting membrane comprising the sulfonated molecule of claim 23.

36. The ion conducting membrane of claim 35 wherein the sulfonated molecule is insoluble in water.

37. A fuel cell comprising the ion conducting membrane of claim 35.

38. A fabric comprising the ion conducting membrane of claim 35.

39. A consumer product comprising the ion conducting membrane of claim 35.

40. A wound dressing comprising the ion conducting membrane of claim 35.

41. A composition comprising a sulfonated molecule, wherein the molecule contains at least one alkene or arene moiety and wherein the molecule is sulfonated from 20 to 99% by weight, based on the total weight of the molecule composition.

42. The composition of claim 41 wherein the molecule is sulfonated from 60 to 99% by weight, based on the total weight of the molecule composition.

43. (canceled)

44. An article comprising a sulfonated molecule, wherein the molecule contains at least one styrene monomeric unit, and wherein the molecule is sulfonated from 60 to 99% by weight, wherein the article is selected from the group consisting of: a membrane, a medical device, a pharmaceutical composition, a fluid-absorbing material, a fuel cell, a capacitor, a wound dressing, a fabric, a building material, a packing material, and a surface coating.

45. A membrane comprising a sulfonated molecule, wherein the molecule contains at least one alkene or arene moiety, and wherein the molecule is sulfonated from 20 to 80% by weight.

46. (canceled)

47. The membrane of claim 45, wherein the molecule contains at least one styrene monomeric unit.

48. A process for manufacturing a sulfonated molecule membrane comprising preparing a sulfonated molecule according to the process of claim 1, and further comprising adapting the sulfonated molecule for use as a membrane, thereby manufacturing the sulfonated molecule membrane.

49. The process of claim 48 wherein the membrane comprises a heat transfer membrane or a fluid transfer membrane.

50. A process for manufacturing a medical device comprising a sulfonated molecule, the method of manufacturing comprising preparing a sulfonated molecule according to the process of claim 1, and further comprising adapting the sulfonated molecule for use as a medical device, thereby manufacturing the medical device comprising a sulfonated molecule.
